(19) United States
(12) Patent Application Publication
(10) Pub. No.: US 2014/0128074 A1
(43) Pub. Date: May 8, 2014

(54) CELL LOADING-BASED CELL TRANSITION

(71) Applicant: Apple Inc., Cupertino, CA (US)

(72) Inventors: Sarma V. VANGALA, San Jose, CA (US); Swaminathan BALAKRISHNAN, Sunnyvale, CA (US); Tarik TABET, Los Gatos, CA (US)

(73) Assignee: Apple Inc., Cupertino, CA (US)

(21) Appl. No.: 14/068,718

(22) Filed: Oct. 31, 2013

Related U.S. Application Data
(60) Provisional application No. 61/722,935, filed on Nov. 6, 2012.
(60) Provisional application No. 61/880,568, filed on Sep. 20, 2013.

(51) Int. Cl. H04W 36/22

(52) U.S. Cl. CPC H04W 36/22
USPC 455/436

(57) ABSTRACT

A method for making a cell transition decision based on cell loading is provided. The method can include a wireless communication device receiving a message sent by a base station associated with a serving cell for the wireless communication device. The message can include loading information indicative of a loading factor for each of at least one neighbor cell. The method can further include the wireless communication device reading at least a portion of the loading information from the message; and selecting a target cell for transition from the at least one neighbor cell based on the read loading information.

### CROSS-REFERENCE TO RELATED APPLICATIONS

This application claims the benefit of priority from both U.S. Provisional Patent Application No. 61/722,935, filed on Nov. 6, 2012, and U.S. Provisional Patent Application No. 61/880,568, filed on Sep. 20, 2013, each of which is hereby incorporated herein by reference in its entity for all purposes.

### FIELD OF THE DESCRIBED EMBODIMENTS

The described embodiments relate generally to wireless communications and more particularly to making cell transition decisions based on cell loading.

### BACKGROUND

During the course of operation, a wireless communication device can transition between cells within one or more cellular networks. For example, a wireless communication device can transition from a serving cell to a neighbor cell in response to a change in received signal strength of the serving cell and/or of the neighbor cell due to a mobility scenario in which the device can move out of the coverage area of the serving cell and toward the coverage area of the neighbor cell.

In some instances, a wireless communication device can transition from a cell using a first radio access technology (RAT) to a cell using a second RAT. For example, cellular networks using newer RAT systems, such as Long Term Evolution (LTE) systems, are being developed and deployed in areas of overlapping coverage with legacy networks. In this regard, coverage of the newer RATs is not yet universal and, further, in some deployments, LTE and other new RATs may not fully support some services that can be handled by legacy networks. Accordingly, LTE networks are often co-deployed in overlapping regions with legacy networks wireless communication devices can transition between cells using various co-deployed RATs as services or coverage may require. For example, in some deployments, a wireless communication device can “fallback” from an LTE cell to a cell implementing a legacy RAT due to scenarios such as loading on the LTE network and lack of coverage of the LTE network. As a further example, in some deployments, an LTE network is not capable of supporting voice calls. Accordingly, when a wireless communication device receives or initiates a voice call while connected to a network that supports data sessions, but not voice calls, the wireless communication device can perform a circuit switched fallback (CSFB) procedure to transition to a cell implementing a legacy RAT that supports voice calls. Transitioning from a cell implementing first RAT to a cell implementing a second RAT, such as in the case of falling back from LTE to a legacy network, is referred to as an inter-RAT (iRAT) handover.

Presently, cell selection decisions, such as in the case of intra-RAT cell transitions and iRAT handovers, are based on signal strength measurements of neighboring cells. However, devices generally do not have any a priori knowledge of loading on a neighbor cell and may transition to a cell that, while having good signal strength, is heavily loaded. Heavily loaded cells can provide poor performance for a wireless communication device, which can negatively impact user experience.

### SUMMARY OF THE DESCRIBED EMBODIMENTS

Some example embodiments disclosed herein provide for making cell transition decisions based on cell loading. More particularly, a base station in accordance with some example embodiments can provide loading information indicative of loading on one or more neighbor cells to a wireless communication device operating within a cell associated with the base station. The wireless communication device of such example embodiments can accordingly receive the loading information and can factor in the indicated loading of candidate neighbor cells when making a cell transition decision. Such example embodiments accordingly enable a wireless communication device to make a more informed cell transition decision, which can result in a wireless communication device transitioning to a less loaded cell, which can provide better service and an improved user experience.

In a first embodiment, a method for making a cell transition decision based at least in part on cell loading is provided. The method of the first embodiment can include a wireless communication device receiving a message sent by a base station associated with a serving cell for the wireless communication device. The message can include loading information indicative of a loading factor for each of at least one neighbor cell. The base station can, for example, be an evolved Node B (eNB), and the serving cell can, for example, implement an LTE RAT. The method of the first embodiment can further include the wireless communication device reading at least a portion of the loading information from the message; and selecting a target cell for transition from the at least one neighbor cell based at least in part on the read loading information.

In a second embodiment, a wireless communication device is provided. The wireless communication device of the second embodiment can include at least one transceiver and processing circuitry coupled with the at least one transceiver. The at least one transceiver can be configured to send data to and receive data from one or more cellular networks. The processing circuitry can be configured to control the wireless communication device of the second embodiment to at least receive a message sent by a base station associated with a serving cell for the wireless communication device. The message can include loading information indicative of a loading factor for each of at least one neighbor cell. The base station can, for example, be an evolved Node B (eNB), and the serving cell can, for example, implement an LTE RAT. The processing circuitry can be further configured to control the wireless communication device of the second embodiment to read at least a portion of the loading information from the message; and select a target cell for transition from the at least one neighbor cell based at least in part on the read loading information.

In a third embodiment, a computer program product for making a cell transition decision based at least in part on cell loading is provided is provided. The computer program product of the third embodiment can include at least one non-transitory computer readable storage medium having program code stored thereon. The program code of the third embodiment can include program code for receiving, to a wireless communication device, a message sent by a base station associated with a serving cell for the wireless communication device. The message can include loading information indicative of a loading factor for each of at least one neighbor cell. The base station can, for example, be an evolved Node B (eNB), and the serving cell can, for example, implement an LTE RAT. The program code of the third embodiment can further include program code for reading at least a portion of the loading information from the message; and program code for selecting a target cell for transition from the at least one neighbor cell based at least in part on the read loading information.

In a fourth embodiment, an apparatus for making a cell transition decision based at least in part on cell loading is provided. The apparatus of the fourth embodiment can include means for receiving, to a wireless communication device, a message sent by a base station associated with a serving cell for the wireless communication device. The message can include loading information indicative of a loading factor for each of at least one neighbor cell. The base station can, for example, be an evolved Node B (eNB), and the serving cell can, for example, implement an LTE RAT. The apparatus of the fourth embodiment can further include means for reading at least a portion of the loading information from the message; and means for selecting a target cell for transition from the at least one neighbor cell based at least in part on the read loading information.

In a fifth embodiment, a method for facilitating a cell transition decision by a wireless communication device based at least in part on cell loading is provided. The method of the fifth embodiment can include a base station receiving loading factor data for one or more neighbor cells; deriving loading information indicative of a loading factor for each of at least one neighbor cell of the one or more neighbor cells from the received loading factor data; generating a message including at least a portion of the derived loading information; and sending the message such that the message is receivable by at least one wireless communication device in a cell served by the base station.

In a sixth embodiment, an apparatus is provided that can be implemented on a base station. The apparatus of the sixth embodiment can include processing circuitry that can be configured to control a base station to at least receive loading factor data for one or more neighbor cells; derive loading information indicative of a loading factor for each of at least one neighbor cell of the one or more neighbor cells from the received loading factor data; generate a message including at least a portion of the derived loading information; and send the message such that the message is receivable by at least one wireless communication device in a cell served by the base station.

In a seventh embodiment, a computer program product for facilitating a cell transition decision by a wireless communication device based at least in part on cell loading is provided. The computer program product of the seventh embodiment can include at least one non-transitory computer readable storage medium having program code stored thereon. The program code of the seventh embodiment can include program code for receiving, to a base station, loading factor data for one or more neighbor cells; program code for deriving loading information indicative of a loading factor for each of at least one neighbor cell of the one or more neighbor cells from the received loading factor data; program code for generating a message including at least a portion of the derived loading information; and program code for sending the message such that the message is receivable by at least one wireless communication device in a cell served by the base station.

In an eighth embodiment, an apparatus for facilitating a cell transition decision by a wireless communication device based at least in part on cell loading is provided. The apparatus of the eighth embodiment can include means for receiving, to a base station, loading factor data for one or more neighbor cells; means for deriving loading information indicative of a loading factor for each of at least one neighbor cell of the one or more neighbor cells from the received loading factor data; means for generating a message including at least a portion of the derived loading information; and means for sending the message such that the message is receivable by at least one wireless communication device in a cell served by the base station.

This Summary is provided merely for purposes of summarizing some example embodiments so as to provide a basic understanding of some aspects of the disclosure. Accordingly, it will be appreciated that the above described example embodiments are merely examples and should not be construed to narrow the scope or spirit of the disclosure in any way. Other embodiments, aspects, and advantages will become apparent from the following detailed description taken in conjunction with the accompanying drawings which illustrate, by way of example, the principles of the described embodiments.

### BRIEF DESCRIPTION OF THE DRAWINGS

The described embodiments and the advantages thereof may best be understood by reference to the following description taken in conjunction with the accompanying drawings. These drawings are not necessarily drawn to scale, and in no way limit any changes in form and detail that may be made to the described embodiments by one skilled in the art without departing from the spirit and scope of the described embodiments.

FIG. 1 illustrates a wireless communication system in accordance with some example embodiments.

FIG. 2 illustrates a wireless communication system in which evolved Node Bs (eNBs) can be configured to exchange loading information via an interface between the eNBs in accordance with some example embodiments.

FIG. 3 illustrates overlapping coverage of a fourth generation network and a legacy network in accordance with some example embodiments.

FIG. 4 illustrates an example mixed-RAT wireless communication system in accordance with some example embodiments.

FIG. 5 illustrates another example mixed-RAT wireless communication system in accordance with some example embodiments.

FIG. 6 illustrates a block diagram of an apparatus that can be implemented on a wireless communication device in accordance with some example embodiments.

FIG. 7 illustrates a block diagram of an apparatus that can be implemented on a base station in accordance with some example embodiments.

FIG. 8 illustrates a block diagram of an apparatus that can be implemented on a network entity that can be configured to provide neighbor cell loading information to a base station in accordance with some example embodiments.

FIG. 9 illustrates a flowchart according to an example method for providing neighbor cell loading information to a base station in accordance with some example embodiments.

FIG. 10 illustrates a flowchart according to an example method for facilitating a cell transition decision based on cell loading in accordance with some example embodiments.

FIG. 11 illustrates a flowchart according to another example method for facilitating a cell transition decision based on cell loading in accordance with some example embodiments.

FIG. 12 illustrates a flowchart according to an example method for making a cell transition decision based on cell loading in accordance with some example embodiments.

FIG. 13 illustrates a flowchart according to another example method for making a cell transition decision based on cell loading in accordance with some example embodiments.

FIG. 14 illustrates a flowchart according to an example method for influencing transition to a neighbor cell based on cell loading in accordance with some example embodiments.

FIG. 15 illustrates a flowchart according to another example method for influencing transition to a neighbor cell based on cell loading in accordance with some example embodiments.

FIG. 16 illustrates a flowchart according to an example method for selectively reading a system information message for updated loading information in accordance with some example embodiments.

### DETAILED DESCRIPTION OF SELECTED EMBODIMENTS

Presently, when a wireless communication device transitions between cells, the selection of a target cell for transitioning is generally based solely on measurements reported by the device. A wireless communication device generally does not have any knowledge of a loading factor of a selected cell until the device has completed transition to the cell and has entered a traffic state on the cell. As such, while a wireless communication device may transition to a cell known to have a good signal strength based on pre-selection measurements, the lack of a priori knowledge of loading on the cell can result in the device transitioning to a heavily loaded cell, which can provide poor performance to the device in spite of the cell having a good signal strength.

Some example embodiments disclosed herein address problems in existing cell selection techniques by enabling wireless communication devices to make cell transition decisions based on cell loading. More particularly, a base station in accordance with some example embodiments can provide loading information indicative of loading on one or more neighbor cells to a wireless communication device operating within a cell associated with the base station. The wireless communication device of such example embodiments can accordingly receive the loading information and can factor in the indicated loading of candidate neighbor cells when making a cell transition decision. For example, the wireless communication device of some example embodiments can consider the loading information in addition to measured signal characteristics of neighbor cells when making a cell transition decision so as to avoid transitioning to a heavily loaded neighbor cell. Such example embodiments accordingly enable a wireless communication device to make a more informed cell transition decision. As such, embodiments disclosed herein can enable wireless communication devices to more consistently transition to cells that are not heavily loaded, which can provide better service and an improved user experience. Further, network operators can benefit due to more consistent load balancing between cells.

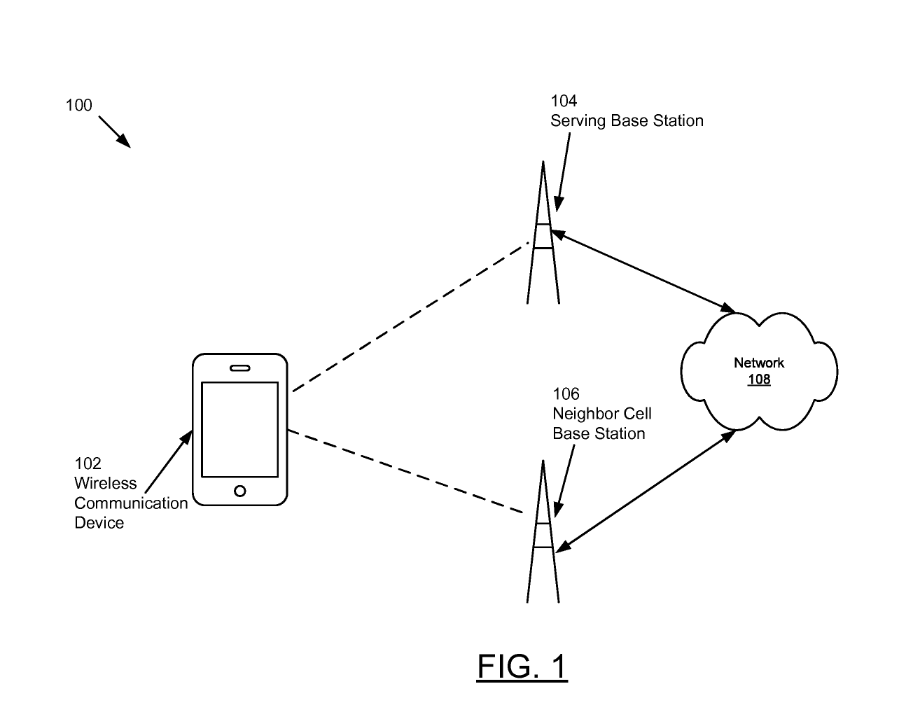

FIG. 1 illustrates a wireless communication system 100 in accordance with some example embodiments. The system 100 can include a wireless communication device 102. By way of non-limiting example, the wireless communication device 102 can be a cellular phone, such as a smart phone device, a tablet computing device, a laptop computing device, or other computing device that can be configured to operate on one or more cellular networks. In some example embodiments, such as those in which the wireless communication device 102 is configured to operate on an LTE network, the wireless communication device 102 can be referred to as user equipment (UE).

The wireless communication device 102 can be operating within a cell, referred to as the serving cell for the wireless communication device 102. The serving cell can have an associated base station, which is illustrated as the serving base station 104 in FIG. 1. In this regard, while operating within the serving cell, the wireless communication device 102 can send signals to and receive signals from the serving base station 104 in support of a network connection. The serving base station 104 can be any base station or other cellular access point that can be configured to provide wireless network access to a wireless communication device 102 operating within signaling range of the serving base station 104. By way of non-limiting example, the serving base station 104 can be an evolved node B (eNB), node B, base transceiver station (BTS), and/or any other type appropriate type of base station depending on a type of RAT implemented by the serving base station 104.

The serving base station 104 and, thus, the cell associated therewith can implement any type of present or future developed cellular RAT in accordance with various example embodiments. For example, in some embodiments, the serving base station 104 can implement an LTE RAT, such as LTE, LTE-Advanced (LTE-A), and/or other present or future developed LTE RAT. In some example embodiments in which the serving base station 104 implements an LTE RAT, the serving base station 104 can be embodied as an eNB. As a further example, in some embodiments, the serving base station 104 can implement a third generation (3G) RAT, such as a Universal Mobile Telecommunications System (UMTS) RAT, such as Wideband Code Division Multiple Access (WCDMA) or Time Division Synchronous Code Division Multiple Access (TD-SCDMA); a CDMA2000 RAT (e.g., 1xRTT) or other RAT standardized by the Third Generation Partnership Project 2 (3GPP2); and/or other 3G RAT. In some example embodiments in which the serving base station 104 implements a 3G RAT, the serving base station 104 can be embodied as a node B. As still a further example, in some embodiments, the serving base station 104 can implement a second generation (2G) RAT, such as a Global System for Mobile Communications (GSM) RAT. In some example embodiments in which the serving base station 104 implements a 2G RAT, the serving base station 104 can be embodied as a BTS. It will be appreciated that the foregoing RATs are provided by way of example, and not by way of limitation. In this regard, it will be appreciated that the serving base station 104 can implement any present or future developed RAT, including, by way of example, various fifth generation (5G) RATs in development.

The serving cell can be adjacent or otherwise proximate to one or more neighbor cells. Each such neighbor cell can have an associated base station. One such neighbor cell base station 106 is illustrated by way of example in FIG. 1. It will be appreciated, however, that the system 100 of some example embodiments can include multiple neighbor cell base stations 106. A neighbor cell can be a candidate for the wireless communication device 102 to transition to from the serving cell in the event that the wireless communication device 102 transitions to another cell, such as through handover, reselection, redirection, and/or other cell transition procedure. Thus, for example, if the wireless communication device 102 is within signaling range of a neighbor cell base station 106, the wireless communication device 102 can transition a network connection from the serving base station 104 to the neighbor cell base station 106.

A neighbor cell base station 106 can be any base station or other cellular access point that can be configured to provide wireless network access to a wireless communication device 102 operating within signaling range of the neighbor cell base station 106 (e.g., within a cell associated with the neighbor cell base station 106). By way of non-limiting example, a neighbor cell base station 106 can be an evolved node B (eNB), node B, base transceiver station (BTS), and/or any other type appropriate type of base station depending on a type of RAT implemented by the respective neighbor cell base station 106, and, thus, by the associated neighbor cell.

A neighbor cell base station 106 and, thus, the neighbor cell associated therewith can implement any type of present or future developed cellular RAT in accordance with various example embodiments. For example, in some embodiments, a neighbor cell base station 106 can implement an LTE RAT, such as LTE, LTE-A, and/or other present or future developed LTE RAT. In some example embodiments in which a neighbor cell base station 106 implements an LTE RAT, the neighbor cell base station 106 can be embodied as an eNB. As a further example, in some embodiments, a neighbor cell base station 106 can implement a 3G RAT, such as a UMTS RAT, such as WCDMA or TD-SCDMA; a CDMA2000 RAT (e.g., 1xRTT) or other RAT standardized by 3GPP2; and/or other 3G RAT. In some example embodiments in which a neighbor cell base station 106 implements a 3G RAT, the neighbor cell base station 106 can be embodied as a node B. As still a further example, in some embodiments, a neighbor cell base station 106 can implement a 2G RAT, such as a GSM RAT. In some example embodiments in which a neighbor cell base station 106 implements a 2G RAT, the neighbor cell base station 106 can be embodied as a BTS. It will be appreciated that the foregoing RATs are provided by way of example, and not by way of limitation. In this regard, it will be appreciated that a neighbor cell base station 106 can implement any present or future developed RAT, including, by way of example, various 5G RATs in development.

In some example embodiments, one or more neighbor cells (e.g., one or more neighbor cell base stations 106) neighboring the serving cell can implement the same RAT as the serving cell for the wireless communication device 102 (e.g., the same RAT as the serving base station 104). For example, in some such embodiments, the serving cell for the wireless communication device 102 and one or more neighbor cells can implement an LTE RAT. Neighbor cells implementing the same RAT as the serving cell can include inter-frequency cells (e.g., cells using a different frequency than the serving cell) and/or intra-frequency cells (e.g., cells using the same frequency as the serving cell). In some example embodiments, the wireless communication device 102 can be operating in a region with a mixed-RAT deployment. In such embodiments, the neighbor cells neighboring the serving cell can additionally or alternatively include one or more neighbor cells implementing one or more RATs other than the RAT implemented by the serving cell. For example, in some such embodiments, the serving cell for the wireless communication device 102 can implement an LTE RAT and the neighbor cells can include one or more neighbor cells implementing a legacy RAT having a circuit switched domain, such as CDMA2000, GSM, UMTS, and/or the like.

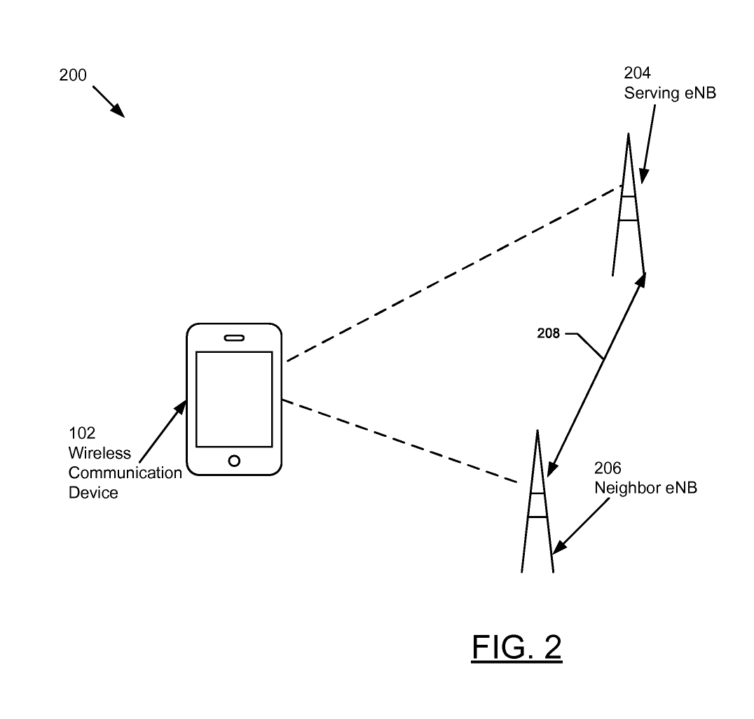

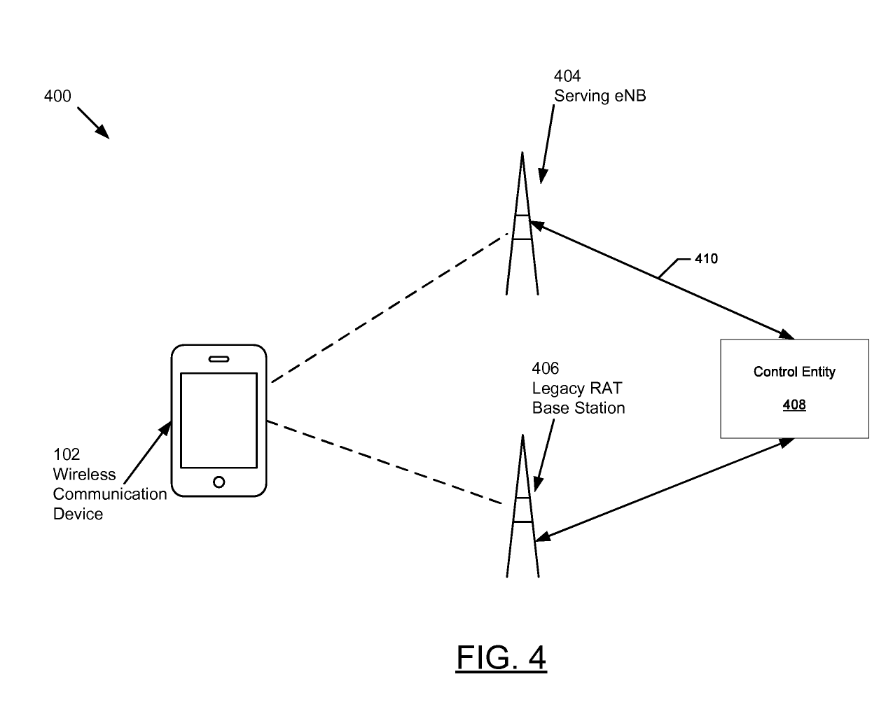

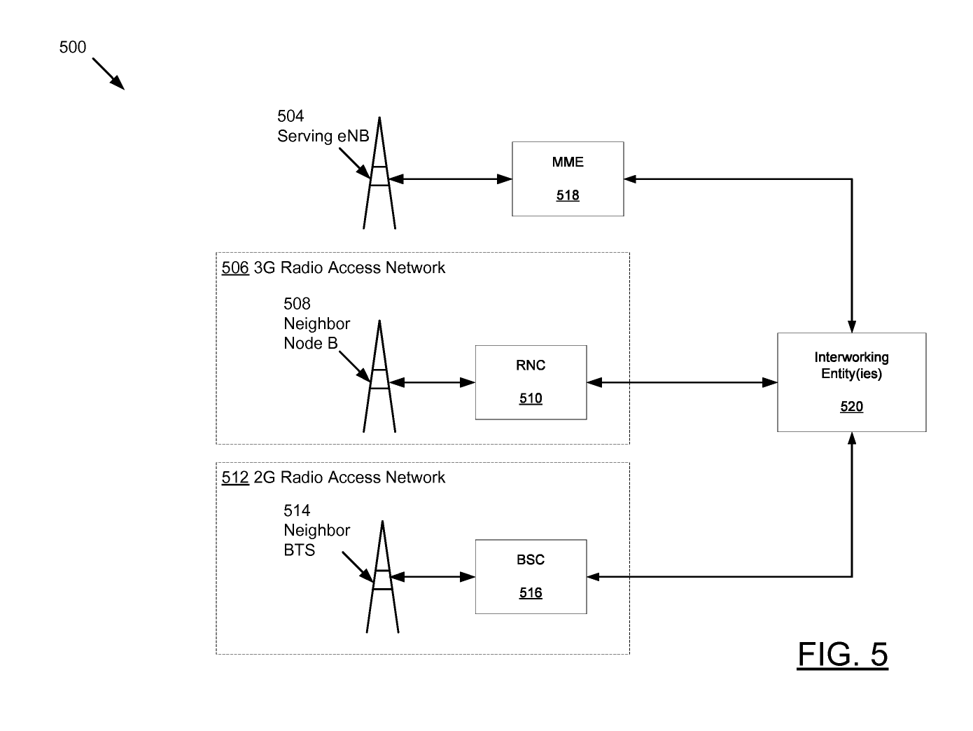

As will be described further herein below, the serving base station 104 of some example embodiments can be provided with access to loading factor data for one or more neighbor cells. Thus, for example, the serving base station 104 can be provided with loading factor data for one or more neighbor base stations 106. A neighbor cell base station 106 can share loading factor data and the serving base station 104 can be provided with accessed to the shared loading factor data via the network 108. The network 108 can include any interface and/or network architecture that can facilitate sharing of loading factor data among base stations using one or more RATs. In this regard, the network 108 can include one or more interfaces, one or more network entities, at least a portion of one or more radio access networks (RANs), at least a portion of one or more core networks (CNs), and/or other architecture that can be configured to support the sharing of loading factor data between base stations. In some example embodiments, such as that illustrated in and described with respect to FIG. 2, the network 108 can include an interface supporting communication between two or more base stations, such as between the serving base station 104 and neighbor cell base station 106 to enable base stations to directly share loading factor data with each other. Additionally or alternatively, in some example embodiments, such as those illustrated in and described with respect to FIG. 4 and FIG. 5, the network 108 can include one or more intermediary network entities that can be configured to collect loading factor data for one or more base stations (e.g., for one or more neighbor cell base stations 106) and to make the collected loading factor data available to the serving base station 104 such that the serving base station 104 of such example embodiments can receive loading factor data for one or more neighbor cell base stations 106 without directly communicating therewith.

As will be described further herein below, the serving base station 104 of some example embodiments can be configured to derive loading information from received loading factor data for neighbor cells and can generate a message including the derived loading information. The serving base station 104 of such example embodiments can be configured to send the message including this loading information such that it is receivable by the wireless communication device 102 and/or other wireless communication devices that can be operating within the serving cell associated with the serving base station 104. For example, in some embodiments, the loading information can be included in system information messages that can be broadcast within the serving cell by the serving base station 104 of some example embodiments. The wireless communication device 102 can receive a message including loading information that can be sent by the serving base station 104, and can use the loading information to select a target cell for transition from the available neighbor cells. Thus, for example, the wireless communication device 102 can select whether or not to transition to a cell associated with a neighbor cell base station 106 based on received loading information.

It will be appreciated that in some example embodiments, a neighbor cell base station 106 can be configured to perform at least some functionality attributed to the serving base station 104 in accordance with various example embodiments, and the serving base station 104 can be configured to perform functionality attributed to the neighbor cell base station 106 in accordance with various example embodiments. In this regard, while the functionality of base stations are illustrated and described herein in terms of “serving” and “neighbor” relative to an example wireless communication device 102 operating within a serving cell, it will be appreciated that a neighbor cell base station 106 can be a “serving” base station relative to an example second device, and the serving base station 104 can be associated with a neighbor cell relative to that second device. As such, for example, a neighbor cell base station 106 can be configured to send messages including loading information for cells, such as the cell associated with the serving eNB 204, neighboring the cell associated with the neighbor cell base station 106 in accordance with some example embodiments.

As discussed above, in some example embodiments, two or more base stations can be configured to directly share loading factor data with each other via an interface between the base stations. FIG. 2 illustrates a wireless communication system 200 in accordance with some such example embodiments. In this regard, FIG. 2 illustrates an example embodiment of the system 100 in which two or more base stations can be configured to directly share loading factor data with each other. In the example system 200, two or more evolved Node Bs (eNBs) can be configured to exchange loading information via an interface 208 between the eNBs. The example of FIG. 2 includes a serving eNB 204 and a neighbor eNB 206. The serving eNB 204 can, for example, be an embodiment of the serving base station 104, and can be associated with as serving cell for the wireless communication device 102. The neighbor eNB 206 can be an embodiment of a neighbor cell base station 106. The interface 208 can, for example, form at least a portion of the network 108. In some example embodiments, the interface 208 can be an X2 interface and/or other interface that can be used to interface eNBs in an LTE network. It will be appreciated that while illustrated as a direct interface, in some example embodiments, the interface 208 can include one or more intermediary network entities and/or can be formed by multiple interfaces that can collectively provide the interface 208.

In accordance with some example embodiments, the neighbor eNB 206 can provide loading factor data indicative of a loading factor for the neighbor eNB 206 to the serving eNB 204 via the interface 208. The serving eNB 204 can derive loading information for the neighbor cell from the loading factor data provided by the neighbor eNB 206 and can include the loading information in a message that can be sent by the serving eNB 204 such that it can be received by the wireless communication device 102. The wireless communication device 102 can accordingly consider the received loading information to facilitate evaluation of whether the neighbor cell associated with the neighbor eNB 206 is a suitable target cell when transitioning from the serving cell.

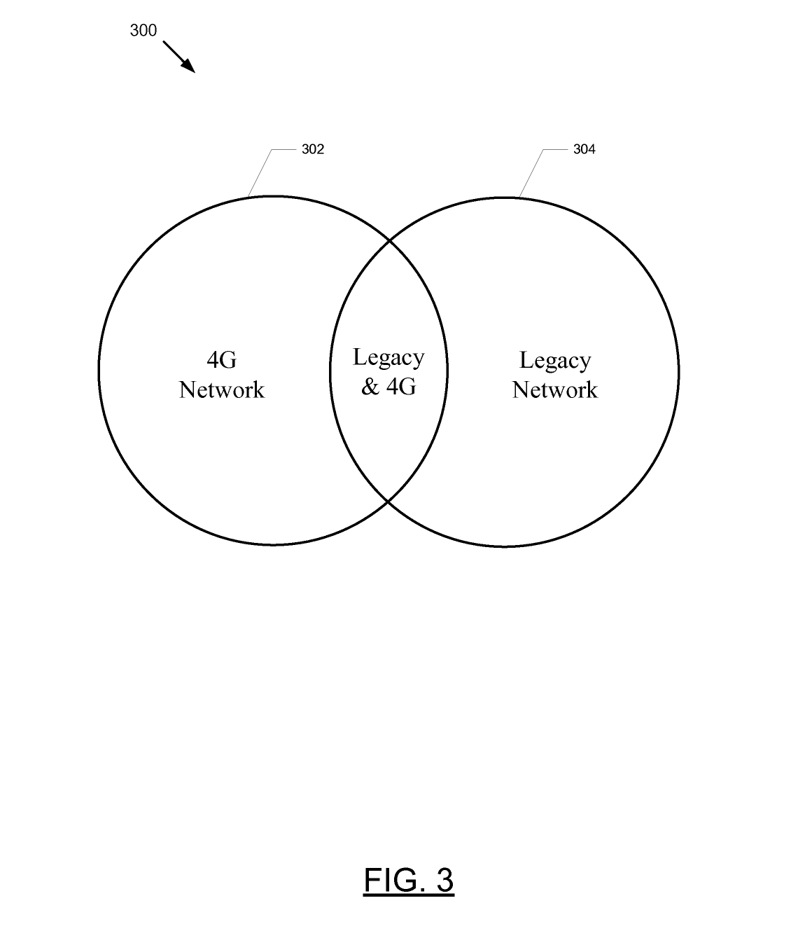

As discussed, in some example embodiments, the wireless communication device 102 can be operating in an area of mixed-RAT deployment such that one or more neighbor cells can use a different RAT than the serving cell for the wireless communication device 102. FIG. 3 illustrates overlapping coverage of a 4G network 302 and a legacy network 304 in a communications system 300 in accordance with some example embodiments. The 4G network 302 can, for example, be a network implementing an LTE RAT, such as an LTE network or an LTE-A network, or other network implementing a 4G RAT. In some embodiments, the 4G network 302 can be a network that can offer faster data rates than legacy networks, such as 2G and 3G networks, but may not support circuit switched (CS) voice calls. The legacy network 304 can, for example, be a legacy network having a CS domain configured to support CS voice calls. By way of non-limiting example, the legacy network 304 can be a 3G network, such as a WCDMA or other UMTS network, such as a TD-SCDMA network. As a further example, the legacy network 304 can be a CDMA2000 network, such as a 1xRTT network, or other network standardized by 3GPP2 that supports a CS domain. As another example, the legacy network 304 can be a 2G network such as a GSM network.

The 4G network 302 and legacy network 304 can each have regions of coverage represented by the respective circles illustrated in FIG. 3. The regions of coverage can overlap, such as illustrated by the overlapping portions of the circles in FIG. 3. A wireless communication device 102 in accordance with some example embodiments can operate on both the 4G network 302 and the legacy network 304. Thus, for example, when the wireless communication device 102 is in a region of overlapping coverage, the wireless communication device can be connected to the 4G network 302 and can fallback to the legacy network 304, such as due to loading of the 4G network 302, a mobility scenario resulting in degraded coverage by the 4G network 302, in response to initiation of a voice call, and/or other similar scenarios for which a device can fallback from the 4G network 302 to the legacy network 304. In this regard, for example, the wireless communication device 102 of some example embodiments can transition from a serving base station 104 that can be implemented on the 4G network 302 to a neighbor cell base station 106 that can be implemented on the legacy network 304.

It will be appreciated, however, that the example illustrated in FIG. 4 is provided by way of example and not by way of limitation. In this regard, some example embodiments can be applied to any inter-Radio Access Technology (iRAT) handover, and not just to an iRAT handover from an LTE or other 4G network to a legacy network. Thus, for example, some embodiments can be applied to transition by a wireless communication device 102 from a serving legacy RAT cell to a neighbor LTE cell. In this regard, for example, a serving base station 104 that can be associated with the serving legacy RAT cell in accordance with some example embodiments can send a message including loading information for the neighbor LTE cell to facilitate selection of a target neighbor cell by the wireless communication device 102 based on the loading information.

FIG. 4 illustrates an example mixed-RAT wireless communication system 400 in accordance with some example embodiments. In this regard, FIG. 4 illustrates an embodiment of the system 100 in which the serving base station 104 and a neighbor cell base station 106 can implement different RATs. The system 400 can include a serving eNB 404 that can be associated with a serving cell for the wireless communication device 102. In this regard, the serving eNB 404 can, for example, be an embodiment of the serving base station 104. The serving eNB 404 can implement an LTE RAT. In this regard, the serving eNB 404 can, for example, be implemented on the 4G network 302.

The system 400 can further include a legacy RAT base station 406 that can be associated with a neighbor cell to the cell associated with the serving eNB 404. In this regard, the legacy RAT base station 406 can, for example, be an embodiment of a neighbor cell base station 106. The legacy RAT base station 406 can implement any legacy RAT, such as a legacy RAT that can include a CS domain. In this regard the legacy RAT base station 406 can, for example, be implemented on the legacy network 304. Accordingly, when the wireless communication device 102 transitions from the cell associated with the serving eNB 404 to the cell associated with the legacy RAT base station 406, an iRAT handover can be performed.

By way of non-limiting example, the legacy RAT base station 406 can implement a 3G RAT, such as a UMTS RAT, such as WCDMA or TD-SCDMA; a CDMA2000 RAT (e.g., 1xRTT) or other RAT standardized by 3GPP2; and/or other 3G RAT. In some example embodiments in which the legacy RAT base station 406 implements a 3G RAT, the legacy RAT base station 406 can be embodied as a node B. As still a further example, in some embodiments, the legacy RAT base station 406 can implement a 2G RAT, such as a GSM RAT. In some example embodiments in which the legacy RAT base station 406 implements a 2G RAT, the legacy RAT base station can be embodied as a BTS.

In some example embodiments, the system 400 can include a control entity 408 that can be implemented on a network associated with the legacy RAT base station 406. The control entity 408 can be interfaced with one or more base stations, including the legacy RAT base station 406. In some example embodiments, the control entity 408 can be implemented on a RAN including the one or more base stations that can be interfaced with the control entity 408, and the control entity 408 can control at least some operation of the base stations within the RAN. By way of non-limiting example, the control entity 408 can be embodied as a radio network controller (RNC) and/or as a base station controller (BSC) in accordance with some example embodiments. As the control entity 408 can be interfaced with the legacy RAT base station 406 (and optionally one or more further base stations), the control entity 408 can have knowledge of a loading factor for the legacy RAT base station 406. For example, a legacy RAT base station 406 can report loading factor data and/or otherwise make observed loading factor data available to the control entity 408.

In some example embodiments, the control entity 408 can be interfaced with a core network of the legacy RAT network in which the legacy RAT base station 406 can be deployed. For example, in some example embodiments, such as some example embodiments in which the legacy RAT implemented by the legacy RAT base station 406 is a CDMA2000 RAT, the control entity 408 can be interfaced with a packet core that can include a packet data serving node (PDSN).

In accordance with some example embodiments, the control entity 408 can be at least indirectly interfaced with one or more eNBs in an LTE network, such as the serving eNB 404, via the interface 410. The interface 210 can, for example, provide a direct interface linking the control entity 408 and the serving eNB 404. Alternatively, as another example, the interface 210 can provide an indirect interface that can include one or more interfaces traversing one or more further entities of the LTE network in which the serving eNB 404 is deployed and/or one or more further entities of the legacy RAT network in which the legacy RAT base station 406 is deployed as intermediate entities on a communications path between the control entity 408 and the serving eNB 404. For example, in some embodiments, one or more elements of an LTE core network, such as a packet data network (PDN) gateway and/or other element of an evolved packet core (EPC) can be disposed as intermediate entities along the interface 210.

In some example embodiments, the interface 210 can be at least partially provided by an interface that can be used to facilitate interworking between different RATs. For example, in some embodiments, such as some embodiments in which the legacy RAT base station 406 implements a CDMA2000 RAT, the interface 210 can include an s102 interface. As another example, in some embodiments, the interface 210 can include an SGs interface.

Regardless of the particular architectural implementation, the interface 410 can represent a communication path that can enable the exchange of data between the serving eNB 404 and control entity 408 such that the control entity 408 can provide loading factor data for one or more base stations, such as the legacy RAT base station 406, to the serving eNB 404 over the interface 410. The interface 410 and control entity 408 can accordingly, for example, form a portion of the network 108 in accordance with some example embodiments.

The serving eNB 404 can be configured to derive loading information for one or more neighbor cells from the loading factor data provided by the control entity 408 and can include the loading information in a message that can be sent by the serving eNB 404 such that it can be received by the wireless communication device 102. The wireless communication device 102 can accordingly consider the received loading information to facilitate evaluation of whether the neighbor cell associated with the legacy RAT base station 406 is a suitable target cell when transitioning from the serving LTE cell.

FIG. 5 illustrates another example mixed-RAT wireless communication system in accordance with some example embodiments. The system 500 illustrated in FIG. 5 can include an LTE network, which can include the serving eNB 504. The serving eNB 504 can, for example, be an embodiment of the serving base station 104 and/or of the serving eNB 404 in accordance with some example embodiments. The system 500 can further include one or more legacy radio access networks (RANs). For example, the system 500 can include a 3G RAN 506 and/or a 2G RAN 512.

The 3G RAN 506 can include one or more neighbor node Bs 508, which can be interfaced with an RNC 510. The RNC 510 can control operation of the neighbor B 508. The neighbor node B 508 can be associated with a cell neighboring the cell associated with the serving eNB 504. As such, the neighbor node B 508 can, for example, be an embodiment of the neighbor cell base station 106 and/or of the legacy RAT base station 406 in accordance with some example embodiments. The RNC 510 can, for example, be an embodiment of the control entity 408. The RNC 510 of some example embodiments can be configured to collect loading factor data for the base station(s) with which it is interfaced, such as the neighbor nodes B 508, can be configured to make this loading factor data available to one or more other base stations, such as to the serving eNB 504, as described further below.

The 2G RAN 512 can include one or more neighbor BTSs 514, which can be interfaced with a BSC 516. The BSC 516 can control operation of the neighbor BTS 514. The neighbor BTS 514 can be associated with a cell neighboring the cell associated with the serving eNB 504. As such, the neighbor BTS 514 can, for example, be an embodiment of the neighbor cell base station 106 and/or of the legacy RAT base station 406 in accordance with some example embodiments. The BSC 516 can, for example, be an embodiment of the control entity 408. The BSC 516 of some example embodiments can be configured to collect loading factor data for the base station(s) with which it is interfaced, such as the neighbor BTS 514, and can be configured to make this loading factor data available to one or more other base stations, such as to the serving eNB 504, as described further below.

The serving eNB 504 can be configured to receive loading factor data for neighboring cells, such as loading factor data for the neighbor node B 508 and/or for the neighbor BTS 514. In this regard, the serving eNB 504 can be at least indirectly interfaced with the RNC 510 and/or with the BSC 516 to receive this loading factor data. In the example of FIG. 5, the serving eNB 504 can be interfaced with a mobility management entity (MME) 518, which can be implemented as part of the LTE network. The MME 518 can be interfaced with the 3G RAN 506 and/or with the 2G RAN 512 via one or more interworking entities 520. In this regard, the interworking entity 520 can include one or more network entities that can be configured to support communication and/or other interworking between RATs, such as handover of a wireless communication device 102 between RATs. In some example embodiment, the interworking entity (or entities) 520 can include one or more of an interworking solution node (IWS), mobile switching center (MSC), Serving General Packet Radio Service (GPRS) Support Node (SGSN), and/or other device that can support communication between and/or other interworking between RATs in a mixed-RAT deployment. The interworking entity (or entities) 520 can, in turn, be interfaced with the RNC 510 and/or BSC 516. As such, in the system 500, an interface can be provided between the serving eNB 504 and one or more of the RNC 510 or BSC 516 via the MME 518 and the interworking entity (or entities) 520) that can be configured to enable the serving eNB 504 to receive loading factor data for a neighbor node B 508 in the 3G RAN 506 and/or for a neighbor BTS 514 in the 2G RAN 512. This interface can, for example, be an embodiment of the interface 410.

The serving eNB 504 can be configured to derive loading information for one or more neighbor cells from the loading factor data that can be provided by the RNC 510 and/or by the BSC 516, and can include the loading information in a message that can be sent by the serving eNB 504 such that it can be received by the wireless communication device 102. The wireless communication device 102 can accordingly consider the received loading information to facilitate evaluation and selection of a neighbor bell for transition.

It will be appreciated that various aspects of the systems illustrated in FIGS. 1, 2, 4, and 5 can be combined into a single system in accordance with some example embodiments. For example, a serving eNB on an LTE network in accordance with some example embodiments can be configured to broadcast system information message from some combination of one or more inter-frequency neighbor LTE cells, one or more intra-frequency neighbor LTE cells, one or more neighboring legacy cells, and/or other combination of neighbor cells. As such, for example, a serving eNB in accordance with some example embodiments can receive loading factor data for one or more inter-frequency and/or intra-frequency LTE cells via an interface(s) 208 with one or more neighbor eNBs and can receive loading factor data for one or more legacy cells that can be provided by one or more control entities, such as control entity 408, RNC 510, BSC 516, and/or the like, such as via an interface 410. The serving eNB can derive loading information for its neighbor cells (e.g., both LTE and legacy neighbor cells) from the received loading factor data, and can include the derived loading information in a message that can be received by the wireless communication device 102.

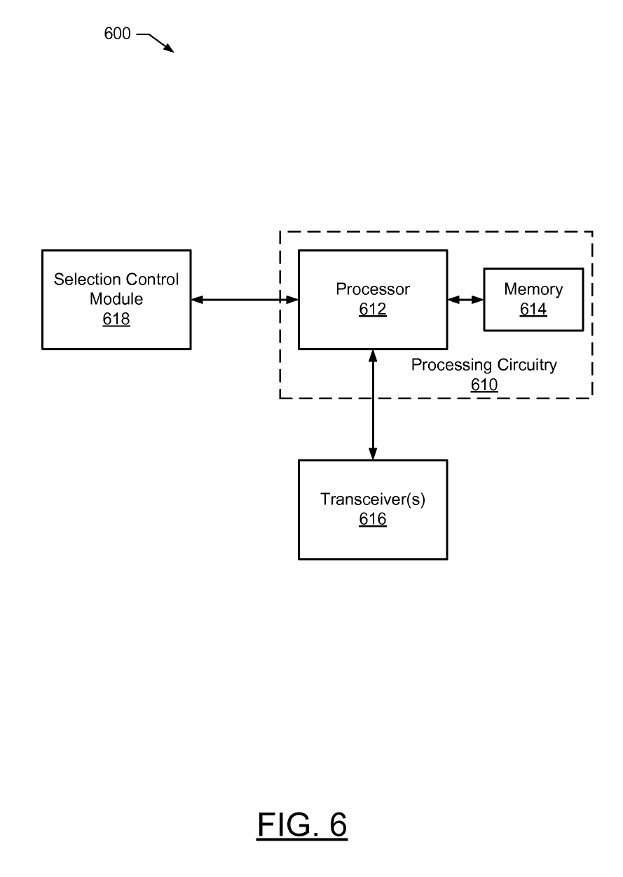

FIG. 6 illustrates a block diagram of an apparatus 600 that can be implemented on a wireless communication device 102 in accordance with some example embodiments. In this regard, when implemented on a computing device, such as wireless communication device 102, apparatus 600 can enable the computing device to operate within one or more of the system 100, system 200, system 400, or system 500 in accordance with one or more example embodiments. It will be appreciated that the components, devices or elements illustrated in and described with respect to FIG. 6 below may not be mandatory and thus some may be omitted in certain embodiments. Additionally, some embodiments can include further or different components, devices or elements beyond those illustrated in and described with respect to FIG. 6.

In some example embodiments, the apparatus 600 can include processing circuitry 610 that is configurable to perform actions in accordance with one or more example embodiments disclosed herein. In this regard, the processing circuitry 610 can be configured to perform and/or control performance of one or more functionalities of the apparatus 600 and, thus, of the wireless communication device 102 in accordance with various example embodiments, and thus can provide means for performing functionalities of the wireless communication device 102 in accordance with various example embodiments. The processing circuitry 610 can be configured to perform data processing, application execution and/or other processing and management services according to one or more example embodiments.

In some embodiments, the apparatus 600 or a portion(s) or component(s) thereof, such as the processing circuitry 610, can include one or more chipsets, which can each include one or more chips. The processing circuitry 610 and/or one or more further components of the apparatus 600 can therefore, in some instances, be configured to implement an embodiment on a chipset. In some example embodiments in which one or more components of the apparatus 600 are embodied as a chipset, the chipset can be capable of enabling a computing device to operate in one or more of the system 100, system 200, system 400, or system 500 when implemented on or otherwise operably coupled to the computing device. Thus, for example, one or more components of the apparatus 600 can provide a cellular baseband chipset that can enable a computing device to operate over one or more cellular networks.

In some example embodiments, the processing circuitry 610 can include a processor 612 and, in some embodiments, such as that illustrated in FIG. 3, can further include memory 614. The processing circuitry 610 can be in communication with or otherwise control a transceiver(s) 616 and/or selection control module 618.

The processor 612 can be embodied in a variety of forms. For example, the processor 612 can be embodied as various hardware-based processing means such as a microprocessor, a coprocessor, a controller or various other computing or processing devices including integrated circuits such as, for example, an ASIC (application specific integrated circuit), an FPGA (field programmable gate array), some combination thereof, or the like. Although illustrated as a single processor, it will be appreciated that the processor 612 can comprise a plurality of processors. The plurality of processors can be in operative communication with each other and can be collectively configured to perform one or more functionalities of the apparatus 600 as described herein. In some example embodiments, the processor 612 can be configured to execute instructions that can be stored in the memory 614 or that can be otherwise accessible to the processor 612. As such, whether configured by hardware or by a combination of hardware and software, the processor 612 capable of performing operations according to various embodiments while configured accordingly.

In some example embodiments, the memory 614 can include one or more memory devices. Memory 614 can include fixed and/or removable memory devices. In some embodiments, the memory 614 can provide a non-transitory computer-readable storage medium that can store computer program instructions that can be executed by the processor 612. In this regard, the memory 614 can be configured to store information, data, applications, instructions and/or the like for enabling the apparatus 600 to carry out various functions in accordance with one or more example embodiments. In some embodiments, the memory 614 can be in communication with one or more of the processor 612, transceiver(s) 616, or selection control module 618 via a bus (or buses) for passing information among components of the apparatus 600.

The apparatus 600 can further include transceiver(s) 616. The transceiver(s) 616 can enable the apparatus 600 to send wireless signals to and receive signals from one or more wireless networks. In this regard, the transceiver(s) 616 can be configured to support a connection between the wireless communication device 102 and one or more cellular network. More particularly, the transceiver(s) 316 can be configured to send data to and receive data from a base station, such as serving base station 104, neighbor cell base station 106, serving eNB 204, neighbor eNB 206, serving eNB 404, legacy RAT base station 406, serving eNB 504, neighbor node B 508, neighbor BTS 514, and/or other base station. As such, the transceiver(s) 616 can be configured to support any type of cellular or other type of RAT that can be implemented in the system 100, system 200, system 400, and/or system 500.

The apparatus 600 can further include selection control module 618. The selection control module 618 can be embodied as various means, such as circuitry, hardware, a computer program product comprising computer readable program instructions stored on a computer readable medium (for example, the memory 614) and executed by a processing device (for example, the processor 612), or some combination thereof. In some embodiments, the processor 612 (or the processing circuitry 610) can include, or otherwise control the selection control module 618. As will be described further herein below, the selection control module 618 of some example embodiments can be configured to select a neighbor cell as a target cell for transition based at least in part on loading information that can be provided by a serving base station in accordance with one or more example embodiments.

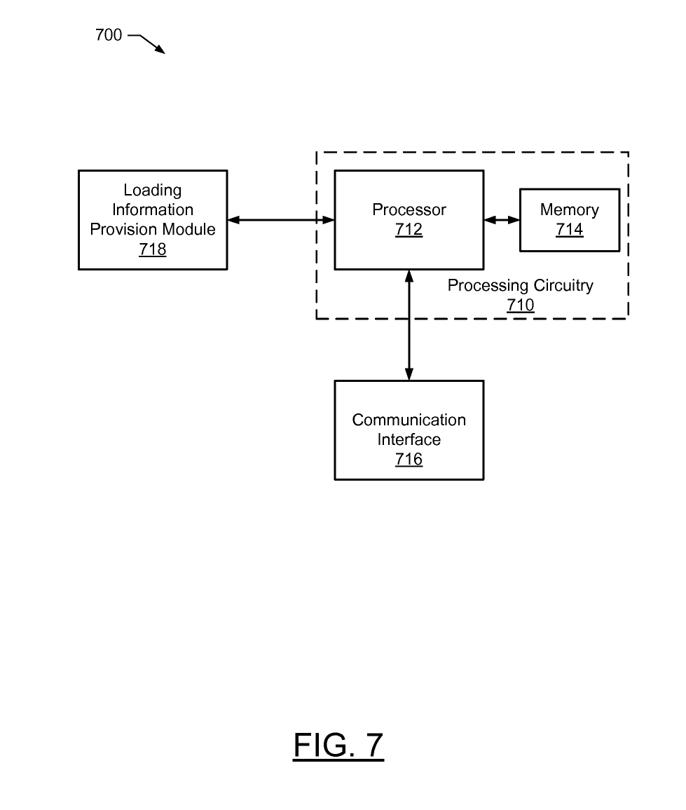

FIG. 7 illustrates a block diagram of an apparatus 700 that can be implemented on a base station in accordance with some example embodiments. In this regard, the apparatus 700 can be implemented on a base station, such as serving base station 104, serving eNB 204, serving eNB 404, serving eNB 505, and/or the like that can be configured to provide loading information for one or more neighbor cells to the wireless communication device 102 in accordance with one or more example embodiments. It will be appreciated that the components, devices or elements illustrated in and described with respect to FIG. 7 below may not be mandatory and thus some may be omitted in certain embodiments. Additionally, some embodiments can include further or different components, devices or elements beyond those illustrated in and described with respect to FIG. 7.

In some example embodiments, the apparatus 700 can include processing circuitry 710 that is configurable to perform actions in accordance with one or more example embodiments disclosed herein. In this regard, the processing circuitry 710 can be configured to perform and/or control performance of one or more functionalities of the apparatus 700 in accordance with various example embodiments, and thus can provide means for performing functionalities of a serving base station, such as serving base station 104, serving eNB 204, serving eNB 404, serving eNB 505, and/or the like in accordance with various example embodiments. The processing circuitry 710 can be configured to perform data processing, application execution and/or other processing and management services according to one or more example embodiments.

In some embodiments, the apparatus 700 or a portion(s) or component(s) thereof, such as the processing circuitry 710, can include one or more chipsets, which can each include one or more chips. The processing circuitry 710 and/or one or more further components of the apparatus 700 can therefore, in some instances, be configured to implement an embodiment on a chipset.

In some example embodiments, the processing circuitry 710 can include a processor 712 and, in some embodiments, such as that illustrated in FIG. 7, can further include memory 714. The processing circuitry 710 can be in communication with or otherwise control a communication interface 716 and/or loading information provision module 718.

The processor 712 can be embodied in a variety of forms. For example, the processor 712 can be embodied as various hardware-based processing means such as a microprocessor, a coprocessor, a controller or various other computing or processing devices including integrated circuits such as, for example, an ASIC (application specific integrated circuit), an FPGA (field programmable gate array), some combination thereof, or the like. Although illustrated as a single processor, it will be appreciated that the processor 712 can comprise a plurality of processors. The plurality of processors can be in operative communication with each other and can be collectively configured to perform one or more functionalities of the apparatus 700 as described herein. In embodiments including a plurality of processors, the processors can be implemented on a single computing device, or can be distributed across a plurality of computing devices that can be collectively configured to provide functionality of the apparatus 700 in accordance with some example embodiments. In some example embodiments, the processor 712 can be configured to execute instructions that can be stored in the memory 714 or that can be otherwise accessible to the processor 712. As such, whether configured by hardware or by a combination of hardware and software, the processor 712 capable of performing operations according to various embodiments while configured accordingly.

In some example embodiments, the memory 714 can include one or more memory devices. In embodiments including multiple memory devices, the memory devices can be implemented on a single computing device, or can be distributed across a plurality of computing devices that can be collectively configured to provide functionality of the apparatus 700 in accordance with some example embodiments. Memory 714 can include fixed and/or removable memory devices. In some embodiments, the memory 714 can provide a non-transitory computer-readable storage medium that can store computer program instructions that can be executed by the processor 712. In this regard, the memory 714 can be configured to store information, data, applications, instructions and/or the like for enabling the apparatus 700 to carry out various functions in accordance with one or more example embodiments. In some embodiments, the memory 714 can be in communication with one or more of the processor 712, communication interface 716, or loading information provision module 718 via a bus (or buses) for passing information among components of the apparatus 700.

The apparatus 700 can further include a communication interface 716. The communication interface 716 can, for example, be configured to enable a base station on which the apparatus 700 can be implemented to communicate with one or more wireless communication devices that can be served by the base station. For example, the communication interface 716 can include a transceiver(s) enabling communication with one or more wireless communication devices 102 in a cell that can be served by a base station on which the apparatus 700 can be implemented. As such, the communication interface 716 can be configured to send messages that can include loading information in accordance with one or more embodiments. The communication interface 716 can additionally or alternatively include one or more interface mechanisms for enabling communication with other devices and/or networks. In this regard, the communication interface 716 can include hardware and/or supporting software for enabling communication with one or more network entities, such as another base station (e.g., via interface 208), a control entity 408 (e.g., via interface 410), an RNC 510, BSC 516, and/or other network entity that can be configured to provide access to loading factor data for neighboring cells. By way of non-limiting example, the communication interface 716 can include a communication modem or other hardware/software for supporting communication via cable, digital subscriber line (DSL), universal serial bus (USB), Ethernet or other wireline networking methods for supporting communication with one or more further networks and/or network entities.

The apparatus 700 can further include loading information provision module 718. The loading information provision module 718 can be embodied as various means, such as circuitry, hardware, a computer program product comprising computer readable program instructions stored on a computer readable medium (for example, the memory 714) and executed by a processing device (for example, the processor 712), or some combination thereof. In some embodiments, the processor 712 (or the processing circuitry 710) can include, or otherwise control the loading information provision module 718. The loading information provision module 718 in accordance with some example embodiments can be configured to derive loading information based on received loading factor data for one or more neighbor cells. The loading information provision module 718 can be further configured to generate a message including the derived loading information, which can be sent by a base station on which the apparatus 700 can be implemented such that the message can be received by a wireless communication device 102 operating within a cell served by the base station.

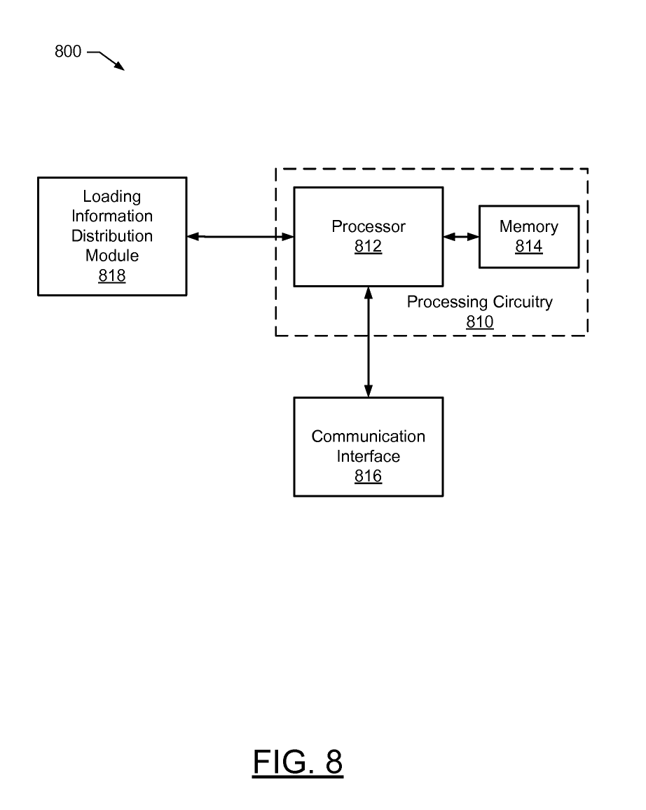

FIG. 8 illustrates a block diagram of an apparatus 800 that can be implemented on a network entity that can be configured to provide neighbor cell loading information to a base station in accordance with some example embodiments. For example, the apparatus 800 can be implemented on a base station, such as neighbor eNB 206 that can be configured to communicate directly with another base station, such as via the interface 208. As another example, the apparatus 800 can be implemented on a control entity, such as control entity 408, RNC 510, BSC 516, and/or the like that can be configured to collect loading factor data for one or more base stations and to make that that loading factor data available to one or more further base stations. It will be appreciated that the components, devices or elements illustrated in and described with respect to FIG. 8 below may not be mandatory and thus some may be omitted in certain embodiments. Additionally, some embodiments can include further or different components, devices or elements beyond those illustrated in and described with respect to FIG. 8. Moreover, in some example embodiments, one or more components of the apparatus 800 can be distributed across multiple network entities, which can be configured to collectively provide functionality of the apparatus 800 in accordance with one or more example embodiments.

In some example embodiments, the apparatus 800 can include processing circuitry 810 that is configurable to perform actions in accordance with one or more example embodiments disclosed herein. In this regard, the processing circuitry 810 can be configured to perform and/or control performance of one or more functionalities of the apparatus 800 in accordance with various example embodiments, and thus can provide means for performing functionalities of a neighbor eNB 206, control entity 408, RNC 510, BSC 516, and/or other network entity that can be configured to provide loading factor data for one or more base stations to one or more further base stations in accordance with various example embodiments. The processing circuitry 810 can be configured to perform data processing, application execution and/or other processing and management services according to one or more example embodiments.

In some embodiments, the apparatus 800 or a portion(s) or component(s) thereof, such as the processing circuitry 810, can include one or more chipsets, which can each include one or more chips. The processing circuitry 810 and/or one or more further components of the apparatus 800 can therefore, in some instances, be configured to implement an embodiment on a chipset.

In some example embodiments, the processing circuitry 810 can include a processor 812 and, in some embodiments, such as that illustrated in FIG. 8, can further include memory 814. The processing circuitry 810 can be in communication with or otherwise control a communication interface 816 and/or loading information distribution module 818.

The processor 812 can be embodied in a variety of forms. For example, the processor 812 can be embodied as various hardware-based processing means such as a microprocessor, a coprocessor, a controller or various other computing or processing devices including integrated circuits such as, for example, an ASIC (application specific integrated circuit), an FPGA (field programmable gate array), some combination thereof, or the like. Although illustrated as a single processor, it will be appreciated that the processor 812 can comprise a plurality of processors. The plurality of processors can be in operative communication with each other and can be collectively configured to perform one or more functionalities of the apparatus 800 as described herein. In embodiments including a plurality of processors, the processors can be implemented on a single computing device, or can be distributed across a plurality of computing devices that can be collectively configured to provide functionality of the apparatus 800 in accordance with some example embodiments. In some example embodiments, the processor 812 can be configured to execute instructions that can be stored in the memory 814 or that can be otherwise accessible to the processor 812. As such, whether configured by hardware or by a combination of hardware and software, the processor 812 capable of performing operations according to various embodiments while configured accordingly.

In some example embodiments, the memory 814 can include one or more memory devices. In embodiments including multiple memory devices, the memory devices can be implemented on a single computing device, or can be distributed across a plurality of computing devices that can be collectively configured to provide functionality of the apparatus 800 in accordance with some example embodiments. Memory 814 can include fixed and/or removable memory devices. In some embodiments, the memory 814 can provide a non-transitory computer-readable storage medium that can store computer program instructions that can be executed by the processor 812. In this regard, the memory 814 can be configured to store information, data, applications, instructions and/or the like for enabling the apparatus 800 to carry out various functions in accordance with one or more example embodiments. In some embodiments, the memory 814 can be in communication with one or more of the processor 812, communication interface 816, or loading information distribution module 818 via a bus (or buses) for passing information among components of the apparatus 800.

The apparatus 800 can further include a communication interface 816. The communication interface 816 can, for example, be configured to enable a network entity, such as a base station (e.g., neighbor eNB 206 and/or the like) or control entity (e.g., control entity 408, RNC 510, BSC 516, and/or the like), on which the apparatus 800 can be implemented to communicate with one or more further network entities. For example, the communication interface 816 can be configured to receive loading factor data for one or more base stations and/or to send loading factor data to another network entity, such as to one or more base stations in accordance with one or more embodiments. As such, it will be appreciated that the communication interface 816 can include one or more interface mechanisms for enabling communication with other devices and/or networks. By way of non-limiting example, the communication interface 816 can include a communication modem or other hardware/software for supporting communication via cable, digital subscriber line (DSL), universal serial bus (USB), Ethernet or other wireline networking methods for supporting communication with one or more further networks and/or network entities.

The apparatus 800 can further include loading information distribution module 818. The loading information distribution module 818 can be embodied as various means, such as circuitry, hardware, a computer program product comprising computer readable program instructions stored on a computer readable medium (for example, the memory 814) and executed by a processing device (for example, the processor 812), or some combination thereof. In some embodiments, the processor 812 (or the processing circuitry 810) can include, or otherwise control the loading information distribution module 818. The loading information distribution module 818 in accordance with some example embodiments can be configured to provide loading factor data for one or more base stations to one or more further base stations in accordance with various example embodiments. In this regard, the loading information distribution module 818 can, for example, be configured to provide loading factor data for one or more neighbor cells to a serving cell of the wireless communication device 102 to enable a serving base station for the wireless communication device 102 to provide neighbor cell loading information to the wireless communication device 102 in accordance with one or more example embodiments.

The loading factor data that can be provided to a base station by the loading information distribution module 818 can include any loading factor data that can be indicative of a loading factor for a cell. In this regard, loading factor can be indicative of loading on a cell, which can be indicative of how many wireless communication devices are connected to (e.g., served by) the cell. By way of non-limiting example, the loading factor data can include a number of wireless communication devices on the cell, an indication of a percentage/amount of a resource(s) available on the cell, an indication of a percentage/amount of a resource(s) allocated on the cell, an indication of an interference or noise floor observed in the cell, and/or other data that can be indicative of a loading factor for a cell. In some example embodiments, the loading factor data can vary depending on a RAT implemented by a cell for which the data is provided.

For example, loading factor data that can be provided for an LTE cell can include one or more of an indication of radio bearer (RB) utilization, such as an indication of a number of RBs allocated per UE in the cell on average; an indication of an uplink (UL) noise level; an indication of interference per RB; an indication of signal to noise ration (SNR) per RB; an indication of a number of active UEs on the cell; an indication of a number of idle UEs on the cell; and/or other data that can be indicative of a loading factor for an LTE cell.

As another example, loading factor data that can be provided for a UMTS cell can include one or more of an indication of orthogonal code availability, an indication of available forward (Fwd) power on the cell, an indication of a Rise over Thermal (RoT) value for the cell, an indication of a number of active UEs on the cell, an indication of a number of passive UEs on the cell, and/or other data that can be indicative of a loading factor for a UMTS cell.

As still a further example, loading factor data that can be provided for a CDMA2000 cell can include one or more of a slot utilization factor for the cell, such as a number of slots allocated and/or available, a percentage of slots allocated and/or available, and/or the like; an indication of the Forward Traffic Valid (FTValid) bits for the cell; an indication of an RoT value for the cell; an indication of an FRAB for the cell; and/or other data that can be indicative of a loading factor for a CDMA2000 cell.

The loading factor data that can be provided for a cell by the loading information distribution module 818 can be associated with a cell identifier for the cell, such as a Cell ID (CID), physical cell ID, a pseudo noise (PN) code, and/or other type of cell identifier that can be used to uniquely identify the cell within a network or portion thereof. The type of cell identifier that can be used in accordance with some example embodiments can vary depending on a type of RAT used by the cell, as, in some cases, different RATs can use different forms of identifiers for cells. As such, it will be appreciated that any type of identification system that can be used to name, identify, and/or otherwise distinguish cells within a network or portion thereof can be used in accordance with various example embodiments.

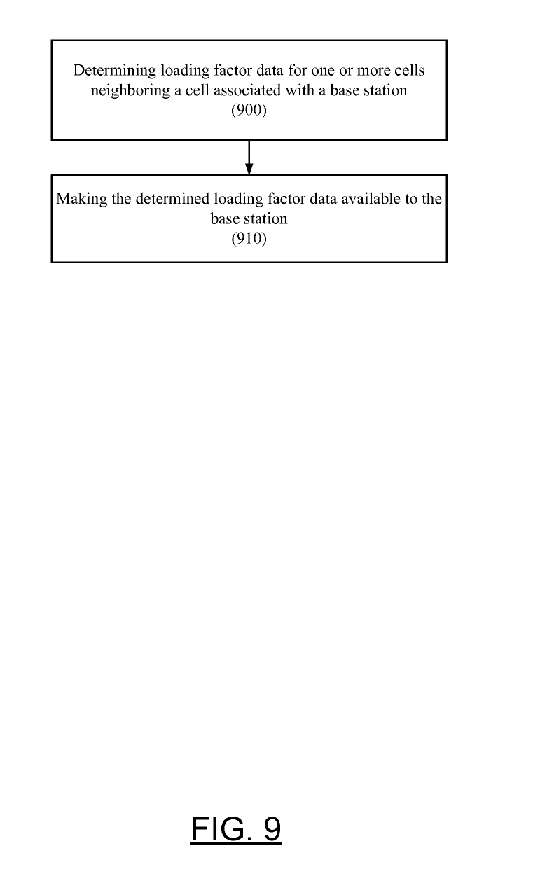

FIG. 9 illustrates a flowchart according to an example method for providing neighbor cell loading information to a base station in accordance with some example embodiments. In this regard, FIG. 9 illustrates operations that can be performed by an apparatus 800, such as can be implemented on a base station, such as neighbor cell base station 106 or neighbor eNB 206, and/or on a control entity, such as control entity 408, RNC 510, BSC 516, and/or the like, which can be configured to provide neighbor cell loading factor to a base station, such as serving base station 104, serving eNB 204, serving eNB 404, serving eNB 504, and/or the like in accordance with one or more example embodiments. One or more of processing circuitry 810, processor 812, memory 814, communication interface 816, or loading information distribution module 818 can, for example, provide means for performing one or more of the operations illustrated in and described with respect to FIG. 9.

Operation 900 can include determining loading factor data for one or more cells neighboring a cell associated with a base station. For example, in an instance in which operation 900 is being performed by a base station, such as neighbor cell base station 106, neighbor eNB 206, and/or the like, operation 900 can include the base station determining loading factor data indicative of its current loading. As another example, in an instance in which operation 900 is being performed by a control entity, such as control entity 408, RNC 510, BSC 516, and/or other control entity that can be configured to control operation of one or more base stations within a RAN, the control entity can be configured to receive loading factor data from and/or otherwise determine loading factor data for base stations within the RAN controlled by the control entity.

Operation 910 can include making the determined loading factor data available to the base station. The loading factor data made available for a particular cell can be associated with a cell identifier for the cell so that the loading factor data can be correlated to the appropriate neighbor cell by the base station.

In some example embodiments, operation 910 can include autonomously sending loading factor data that can be determined in operation 900 to a base station(s). For example, a message including the loading factor data can be sent over an interface via which it can be received by one or more base stations, such as, by way of non-limiting example, over the network 108, the interface 208, the interface 410, and/or the like. In such example embodiments, the loading factor data can be sent to a base station on a scheduled basis or periodic basis. As another example, in some example embodiments, loading factor data can additionally or alternatively be sent to a base station on an aperiodic basis, such as in response to a change or other update to previously provided loading factor data.

In some example embodiments in which operation 910 includes autonomously sending loading factor data, a message(s) including the loading factor data can be a generic message including loading factor data for cells known to the network entity performing operation 910 without regard for whether the cells are neighbor cells for a base station that can receive the message. For example, a message including loading factor data can be sent over an interface via which the message can be received by one or more base stations whose identity may not be known to the network entity that can perform operation 910.

Alternatively, in some example embodiments, operation 910 can include sending a message addressed to or otherwise designated for a particular base station, which can include loading factor data only for a cell(s) that neighbors the designated base station. In such example embodiments, the network entity performing operation 910 can have knowledge of a network deployment structure, and thus can be aware of the identities of neighbor cells for a particular base station.

In some such example embodiments, a message including loading factor data that can be sent to a base station attendant to performance of operation 910 can include a sequence number or other version information. If the loading factor data has been updated since a most recently sent message, then the sequence number can be incremented or otherwise changed to reflect that the message includes updated loading factor data. If, however, the message includes only loading factor data that is identical to the most recently sent message, then the sequence number from the most recently sent message can be repeated. As such, a base station receiving the message can use the sequence number to determine whether the message includes updated loading factor data that should be read from the message and processed to derive updated loading information for provision to one or more wireless communication devices that can be served by the base station. Thus, for example, if a message having a sequence number duplicative of a previously received message is seen by the base station, the base station can ignore the message.

In some example embodiments, operation 910 can include sending loading factor data to a base station in response to a request or other query that can be received from the base station. In such example embodiments, a base station, such as serving base station 104, serving eNB 204, serving eNB 404, serving eNB 504, and/or the like can be configured to send a request for loading factor data, and operation 910 can be performed in response to the request. In some such embodiments, the request from the base station can specify one or more specific neighbor cells for the base station, and the response can include loading factor data for the requested neighbor cell(s). As another example, in some such example embodiments, the request may not specify any particular neighbor cells for the requesting base station, but the network entity performing operation 910 can be aware of the identity of one or more neighbor cells of the base station and can provide loading factor data only for a cell(s) that neighbors the requesting base station. As still a further example, in some such embodiments, the request can be a general request for loading factor data, and the response can include loading factor data for all cells known to the network entity performing operation 910 regardless of whether the cells are neighbor cells for the requesting base station.

A base station (e.g., serving base station 104, serving eNB 204, serving eNB 404, serving eNB 504, and/or the like) serving the wireless communication device 102 can receive loading factor data for one or more neighbor cells that can be provided or otherwise made available by a network entity, such as another base station (e.g., a neighbor cell base station 106, neighbor eNB 204, and/or the like) and/or a control entity (e.g., control entity 408, RNC 510, BSC 516, and/or the like), such as attendant to performance of operation 910. A loading information provision module 718 that can be associated with the base station can be configured to derive loading information for one or more neighbor cells from the received loading factor data. In this regard, the loading information provision module 718 can be configured to process the loading factor data into a form that can be inserted into a message that can be sent to and interpreted by the wireless communication device 102 so that the wireless communication device 102 can determine a loading factor for one or more neighbor cells and select a target cell for transition based at least in part on the loading information.

In some example embodiments, the derived loading information can include loading information defined in the same form and/or metric(s) as at least a portion of the loading factor data received by the base station. Additionally or alternatively, in some example embodiments, deriving the loading information can include deriving a new and/or otherwise modified loading information metric from the received loading factor data, which can be interpreted by the wireless communication device 102. For example, the derived loading information can include a metric indicative of a loading factor for a cell that can be derived from a received slot utilization factor and/or FTValid bits.

The loading information provision module 718 can be further configured to generate a message including the derived loading information. In this regard, the loading information provision module 718 can, for example, generate a message including one or more information elements including loading information indicative of a loading factor(s) for a neighbor cell(s). For example, the generated message can include a list identifying one or more neighbor cells (e.g., a neighbor cell list) along with loading information indicative of a loading factor associated with each of one or more of the identified neighbor cells. As an example, the message can list a series of one or more cell identifiers, such as CIDs, PN codes, and/or the like, for one or more neighbor cells along with an associated loading factor indication for each of one or more of the listed cell identifiers.

In some example embodiments, the loading information can be organized based within one or more messages based on neighbor cell characteristics, such as RAT type and/or frequency characteristics. For example, loading information for any intra-frequency neighbor cells can be grouped into one set of neighbor cell loading information. Loading information for any inter-frequency neighbor cells can be grouped into another set of neighbor cell loading information. Loading information for any neighbor cells implementing a UMTS RAT can be grouped into a further set of neighbor cell loading information. Loading information for any neighbor cells implementing a GSM RAT can be grouped into still a further set of neighbor cell loading information. Loading information for any neighbor cells implementing a CDMA2000 RAT can be grouped into yet another set of neighbor cell loading information.

The loading information provision module 718 can be further configured to cause a base station on which the apparatus 700 can be implemented to send a message containing loading information such that it is receivable by at least one wireless communication device in the cell served by the base station. In some example embodiments, the message can be sent (e.g., via unicast, multicast, or the like) to one or more specifically designated wireless communication devices, such as the wireless communication device 102, that can be served by the base station. Additionally or alternatively, in some embodiments, the message can be broadcast by the base station such that it can be received by any wireless communication device operating within the cell.

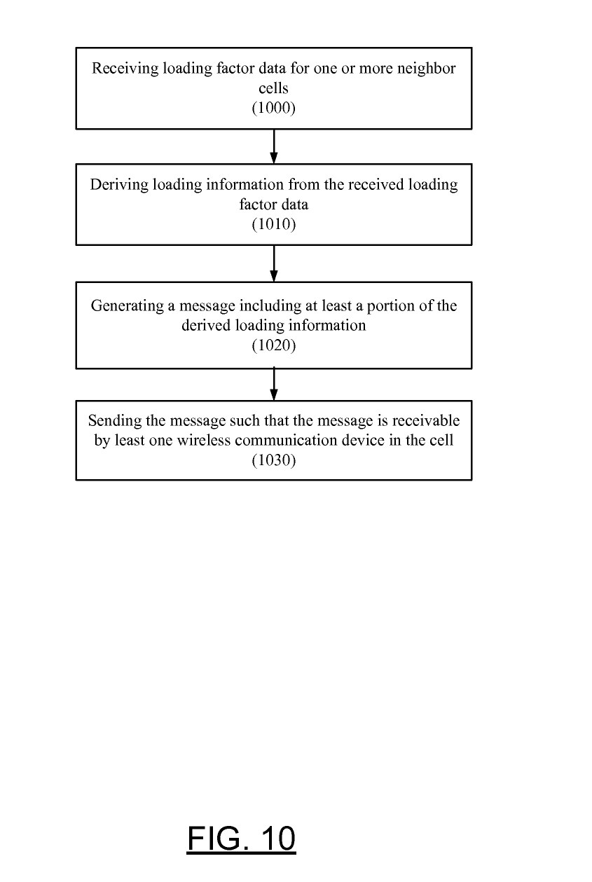

FIG. 10 illustrates a flowchart according to an example method for facilitating a cell transition decision based on cell loading in accordance with some example embodiments. In this regard, FIG. 10 illustrates operations that can be performed by a base station, such as serving base station 104, serving eNB 204, serving eNB 404, serving eNB 504, and/or the like in accordance with some example embodiments. One or more of processing circuitry 710, processor 712, memory 714, communication interface 716, or loading information provision module 718 can, for example, provide means for performing one or more of the operations illustrated in and described with respect to FIG. 10.

Operation 1000 can include a base station receiving loading factor data for one or more neighbor cells. The received loading factor data can, for example, be provided by a network entity, such as another base station (e.g., neighbor cell base station 106, neighbor eNB 206, and/or the like) and/or a control entity (e.g., control entity 408, RNC 510, BSC 516, and/or the like), attendant to performance of operation 910 by the network entity. In some example embodiments in which a base station can serve multiple cells, operation 1000 can further include the base station determining loading factor data for one or more second cells served by the base station that neighbor a first cell served by the base station.

Operation 1010 can include the base station deriving loading information from the loading factor data received and/or otherwise determined by the base station in operation 1000. Operation 1020 can include the base station generating a message including at least a portion of the derived loading information. Operation 1030 can include the base station sending the message such that the message is receivable by at least one wireless communication device operating within the cell served by the base station.

In some example embodiments, the message that can be generated and sent by a base station, such as attendant to performance of operations 1020 and 1030 can be a system information message that can be broadcast by the base station. In this regard, some example embodiments include loading information for one or more neighbor cells in a broadcast system information message. For example, loading information can be inserted into one or more system information blocks (SIBs) in accordance with some example embodiments. In some example embodiments, loading information can be inserted into one or more SIBs that can be used to provide reselection information to wireless communication devices, such as, by way of non-limiting example one or more of SIBs 3-8. In some example embodiments, neighbor cell loading information can be organized into one or more SIBs based at least in part on neighbor cell characteristics, such as RAT type and/or frequency characteristics.

For example, in some example embodiments, loading information for any intra-frequency neighbor cells can be inserted into a SIB 4. As a further example, in some example embodiments, loading information for any inter-frequency neighbor cells can be inserted into a SIB 5. As another example, in some example embodiments, loading information for any neighbor cells implementing a UMTS RAT can be inserted into a SIB 6. As still a further example, in some example embodiments, loading information for any neighbor cells implementing a GSM RAT can be inserted into a SIB 7. As yet another example, in some example embodiments, loading information for any neighbor cells implementing a CDMA2000 RAT can be inserted into a SIB 8.

A non-limiting example SIB 4 including loading information for intra-frequency neighbor cells in accordance with some such example embodiments can be defined as follows, with loading information that can be added to the SIB 4 in accordance with such embodiments underlined and italicized:

SIB4:

```
intraFreqNeighCellList
[1-16 instances]
List of intra-frequency neighboring cells with specific cell re-selection
parameters
IntraFreqNeighCellInfo
  physCellId Physical CellID of the neighbor cell
  q-OffsetCell  specifies the offset between the two cells.
  Value −24 - +24dB
  Loading - RB Utilization, UL noise level, Interference per RB, SNR
      per RB, # of Active UEs, # of Idle UEs, and/or
      other loading information
intraFreqBlackCellList
[1-16 instances]
List of blacklisted intra-frequency neighboring cells. These type of cells
      are not considered for cell re-selection
csg_PhysCellIdRange Set of physical cell identities reserved for CSG
      cells on the frequency on which this field was received. The
      received csg-PhysCellIdRange applies if less than 24 hours has
      elapsed since it was received and it was received in the same
      primary PLMN. This field is Optional (mandatory for CSG cell)
```

A non-limiting example SIB 5 including loading information for inter-frequency neighbor cells in accordance with some such example embodiments can be defined as follows, with loading information that can be added to the SIB 5 in accordance with such embodiments underlined and italicized:

SIB5:

```
InterFreqCarrierFreqInfo  can be specified up to 8 carrier frequencies
dl-CarrierFreq carrier frequency helps the UE to search the cells
q-RxLevMin minimum RSRP value of the inter-frequency cell. Value −70 to
−22 dBm.
Actual value: signaled value * 2
p-Max maximum allowed UL transmit power of the cell
t-ReselectionEUTRA defines the time to trigger for cell reselection. Value 0 to 7 sec.
t-ReselectionEUTRA-SF  scaling factors for Medium and High mobility
threshX-High # Threshold (in dB) used by UE for cell re-selection to a HIGHER priority
# The Srxlev of the candidate cell is greater then threshX_High
# Value 0 to 31 dB. Actual value= Signaled value * 2
threshX-Low # Threshold (in dB) used by UE for cell re-selection to a LOWER priority
# Cell re-selection is allowed only when Srxlev of the candidate cell is greater then
      threshX_Low and RSRP of serving cell is less than the value of
      ThreshServingLow singaled within SIB3
# Value 0 to 31 dB. Actual value= Signaled value * 2
allowedMeasBandwidth  defined in terms of Resource blocks associated with a
      specific channel bandwidth
cellReselectionPriority  defines the Absolute priority of the frequency layer
neighCellConfig  information regarding the neighboring cells
q-OffsetFreq defines the RSRP measurement offset, applied to all cells on the specified
      RF carrier
Loading - RB Utilization, UL noise level, Interference per RB, SNR per RB, # of Active
      UEs, # of Idle UEs, and/or other loading information
interFreqBlackCellList  the mentioned cells are not considered for cell reselection
```

A non-limiting example SIB 6 including loading information for UMTS neighbor cells in accordance with some such example embodiments can be defined as follows, with loading information that can be added to the SIB 6 in accordance with such embodiments underlined and italicized:

SIB6:

```
carrierFreqListUTRA_FDD/TDD Information specified for up to 16 instances of RF
        carriers for FDD or TDD
  carrierFreq  carrier frequency helps the UE to search
  cellReselectionPriority  defines the absolute priority of the UMTS. Value 0-7, 0 is
      the lowest priority
  Loading: Orthogonal code availability, Available Fwd power, Rise over Thermal
      value, # of Active UEs, # of passive UEs, and/or other loading information
  threshX_High #  Threshold (in dB) used by UE for cell re-selection to a HIGHER
      priority UMTS frequency
  # The Srxlev of the candidate cell is greater then threshX_High
  # Value 0 to 31 dB. Actual value= Signaled value * 2
    threshX_Low  # Threshold (in dB) used by UE for cell re-selection to a LOWER
      priority UMTS frequency
  # Cell re-selection is allowed only when Srxlev of the candidate cell is greater then
      threshX_Low and RSR of serving cell is less than the value of ThreshServingLow
      signaled within SIB3
  # Value 0 to 31 dB. Actual value= Signaled value * 2
    q_RxLevMin  minimum RSCP requirement for candidate UMTS cell. Value −60
      to −13 dB. Actual value= Signaled value * 2 +1
    p_Max Value applicable for the intra-frequency neighboring E-UTRA cells. If
      absent the UE applies the maximum power according to the UE capability
    q_QualMin #  minimum Ec/Io requirement for candidate UMTS cell.
  Value −24 to 0 dB
  # applicable for FDD only
  t_ReselectionUTRA  # defines the time to trigger cell re-selection
  # value 0 - 7 seconds
  t_ReselectionUTRA_SF # defines the time to trigger cell re-selection
  # value 0 - 7 seconds
  # Scaling factors used for Medium and High mobility
  # Scaling Factors value 0.25, 0.5, 0.75, 1.0. These values decrease the value of
      T_reselection which allows more rapid cell re-selections
```

A non-limiting example SIB 8 including loading information for CDMA2000 neighbor cells in accordance with some such example embodiments can be defined as follows, with loading information that can be added to the SIB 8 in accordance with such embodiments underlined and italicized:

SIB8:

| | |
|---|---|
| SystemInformationBlockType8 ::= | SEQUENCE { |
| systemTimeInfo | |
| SystemTimeInfoCDMA2000 | OPTIONAL, -- Need OR |

| | |
|---|---|
| searchWindowSize | INTEGER |

| | |
|---|---|
| (0..15) | OPTIONAL, -- Need OR |

| | |
|---|---|
| parametersHRPD | SEQUENCE { |
| preRegistrationInfoHRPD | PreRegistrationInfoHRPD, |
| cellReselectionParametersHRPD | |

| | |
|---|---|
| CellReselectionParametersCDMA2000 | OPTIONAL -- Need OR |
| } | |

OPTIONAL, -- Need OR

| | |
|---|---|
| parameters1XRTT | SEQUENCE { |
| csfb-RegistrationParam1XRTT | CSFB- |

| | |
|---|---|
| RegistrationParam1XRTT | OPTIONAL, -- Need OP |

| | |
|---|---|
| longCodeState1XRTT | BIT STRING (SIZE |

| | |
|---|---|
| (42)) | OPTIONAL, -- Need OR |

cellReselectionParameters1XRTT

| | |
|---|---|
| CellReselectionParametersCDMA2000 | OPTIONAL -- Need OR |
| } | |

OPTIONAL, -- Need OR

...
}
CellReselectionParametersCDMA2000 ::= SEQUENCE {

| | |
|---|---|
| bandClassList | BandClassListCDMA2000, |
| neighCellList | NeighCellListCDMA2000, |

| | |
|---|---|
| t-ReselectionCDMA2000 | T-Reselection, |
| t-ReselectionCDMA2000-SF | SpeedStateScaleFactors |
| OPTIONAL -- Need OP | |
| } | |
| NeighCellListCDMA2000 ::= | SEQUENCE (SIZE (1..16)) OF |
| NeighCellCDMA2000 | |
| NeighCellCDMA2000 ::= SEQUENCE { | |

| | |
|---|---|
| bandClass | BandclassCDMA2000, |

```
      neighCellsPerFreqList
NeighCellsPerBandclassListCDMA2000
      Loading: Slot Utilization factor, RoT, FRAB, #FTValid Bit, and/or other loading
      information
}
NeighCellsPerBandclassListCDMA2000 ::= SEQUENCE (SIZE (1..16)) OF
NeighCellsPerBandclassCDMA2000
```

| | |
|---|---|
| NeighCellsPerBandclassCDMA2000 ::= | SEQUENCE { |

| | |
|---|---|
| arfcn | ARFCN-ValueCDMA2000, |

| | |
|---|---|
| physCellIdList | PhysCellIdListCDMA2000 |
| } | |

| | |
|---|---|
| PhysCellIdListCDMA2000 ::= | SEQUENCE (SIZE (1..16)) OF |
| PhysCellIdCDMA2000 | |
| BandClassListCDMA2000 ::= | SEQUENCE (SIZE (1..maxCDMA- |
| BandClass)) OF BandClassInfoCDMA2000 | |

| | |
|---|---|
| BandClassInfoCDMA2000 ::= | SEQUENCE { |

| | |
|---|---|
| bandClass | BandclassCDMA2000, |
| cellReselectionPriority | |

| | |
|---|---|
| CellReselectionPriority | OPTIONAL, -- Need OP |

| | |
|---|---|
| threshX-High | INTEGER (0..63), |

| | |
|---|---|
| threshX-Low | INTEGER (0..63), |
| ... | |

As another example, in some example embodiments in which neighbor cell loading information for neighboring CDMA2000 cells can be included in a SIB 8, at least a portion of the loading information for a neighboring CDMA2000 cell(s) can be included within the PhysCellIDListCDMA2000 information element. In such example embodiment, the physical cell ID list can include a list of one or more PN codes with associated loading factor information. In this regard, each such PN code can identify a cell, sector, and/or other logical subdivision (collectively referred to herein as “cells” unless otherwise noted). For example, in some such embodiments 8 bits of loading information can be included for each PN code, such as in the following example:

PN 1: xxxxxxxx (loading information indicating the loading factor for
PN 1)
PN 2: xxxxxxxx (loading information indicating the loading factor for
PN 2)
...
PN n: xxxxxxxx (loading information indicating the loading factor for
PN n)

It will be appreciated, however, that embodiments are not limited to the inclusion of 8 bits of loading information for each cell or PN code. In this regard, fewer or additional bits can be used to indicate a loading factor for a particular cell in accordance with some such example embodiments in which neighbor cell loading information can be included in a PhysCellIDListCDMA2000 information element of a SIB 8.

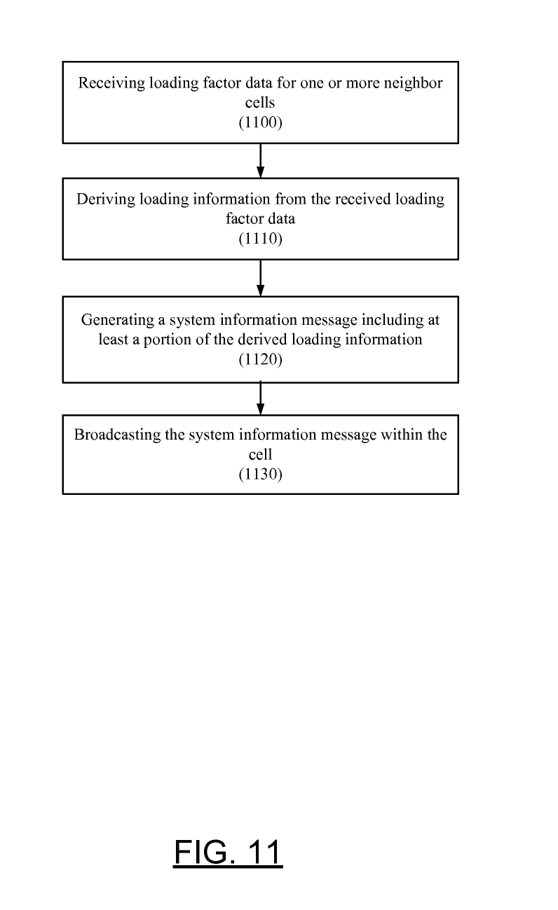

FIG. 11 illustrates a flowchart according to another example method for facilitating a cell transition decision based on cell loading in accordance with some example embodiments. In this regard, FIG. 11 illustrates an embodiment of the method of FIG. 10 in which cell loading information can be broadcast in a system information message in accordance with some example embodiments. The operations illustrated in and described with respect to FIG. 11 can be performed by a base station, such as serving base station 104, serving eNB 204, serving eNB 404, serving eNB 504, and/or the like in accordance with some example embodiments. One or more of processing circuitry 710, processor 712, memory 714, communication interface 716, or loading information provision module 718 can, for example, provide means for performing one or more of the operations illustrated in and described with respect to FIG. 11.

Operation 1100 can include a base station receiving loading factor data for one or more neighbor cells. In this regard, operation 1100 can correspond to an embodiment of operation 1000. Operation 1110 can include the base station deriving loading information from the loading factor data received and/or otherwise determined by the base station in operation 1100. In this regard, operation 1110 can correspond to an embodiment of operation 1010.

Operation 1120 can include the base station generating a system information message including at least a portion of the derived loading information. In this regard, operation 1120 can correspond to an embodiment of operation 1020 in which loading information can be included in a system information message.

In some example embodiments, operation 1120 can include inserting the loading information can be inserted into one or more SIBs that can form the system information message, such as, by way of non-limiting example one or more of SIBs 3-8. For example, in some example embodiments, the loading information can be included in one or more SIBs that can be used to provide reselection information to wireless communication devices.

In some example embodiments, operation 1120 can include organizing the loading information within the system information message, such as within one or more SIBs contained therein, based at least in part on respective neighbor cell characteristics, such as RAT type and/or frequency characteristics of the neighbor cells. For example, in some example embodiments, loading information for any intra-frequency neighbor cells can be inserted into a SIB 4. As a further example, in some example embodiments, loading information for any inter-frequency neighbor cells can be inserted into a SIB 5. As another example, in some example embodiments, loading information for any neighbor cells implementing a UMTS RAT can be inserted into a SIB 6. As still a further example, in some example embodiments, loading information for any neighbor cells implementing a GSM RAT can be inserted into a SIB 7. As yet another example, in some example embodiments, loading information for any neighbor cells implementing a CDMA2000 RAT can be inserted into a SIB 8.

Operation 1130 can include the base station broadcasting the system information message within the cell such that it can be received by wireless communication devices operating within the cell served by the base station. In this regard, operation 1130 can correspond to an embodiment of operation 1030 in which a message including neighbor cell loading information can be broadcast by a base station.

In some example embodiments in which loading information is broadcast in a system information message, the loading information can, for example, be included in each system information message, or at least each system information message of a type in which the loading information can be included, such as one or more of SIBs 3-8, that can be broadcast by the base station. Alternatively, the loading information can be periodically included in broadcast system information messages, such as by way of non-limiting example, every fifth system information message that can be broadcast by the base station. In embodiments in which loading information can be periodically broadcast, the wireless communication device 102 can accordingly be configured to recognize which system information messages will include loading information based on the periodic broadcast schedule that can be used by the serving base station.

In some example embodiments, a broadcast system information message including neighbor cell loading information can include a sequence number or other version information. In this regard, in some such example embodiments, a sequence number and/or other version indication can be updated each time loading information in the message is updated. If, however, a system information message includes loading information that is identical to a most recently broadcast system information message, the sequence number of the prior system information message can be repeated so as to indicate that the system information message is duplicative of the prior system information message. As such, a wireless communication device 102 seeing the broadcast system information message can recognize from the sequence number whether the system information message includes updated loading information that should be read by the wireless communication device 102. In this regard, if a duplicate system information message is seen by the wireless communication device 102, the wireless communication device 102 can ignore the system information message without expending resources reading the system information message.

The selection control module 618 of a wireless communication device 102 receiving a message including loading information sent by a base station can be configured to use the loading information to select a target cell for transition from the available neighbor cells. In this regard, for example, the selection control module 618 can be configured to prefer a cell having a lighter loading factor to a sector that is more heavily loaded. Additionally or alternatively, the selection control module 618 can be configured to eliminate a sector that is excessively loaded. For example, a cell having a loading factor exceeding a threshold loading factor can be eliminated from consideration in accordance with some example embodiments.

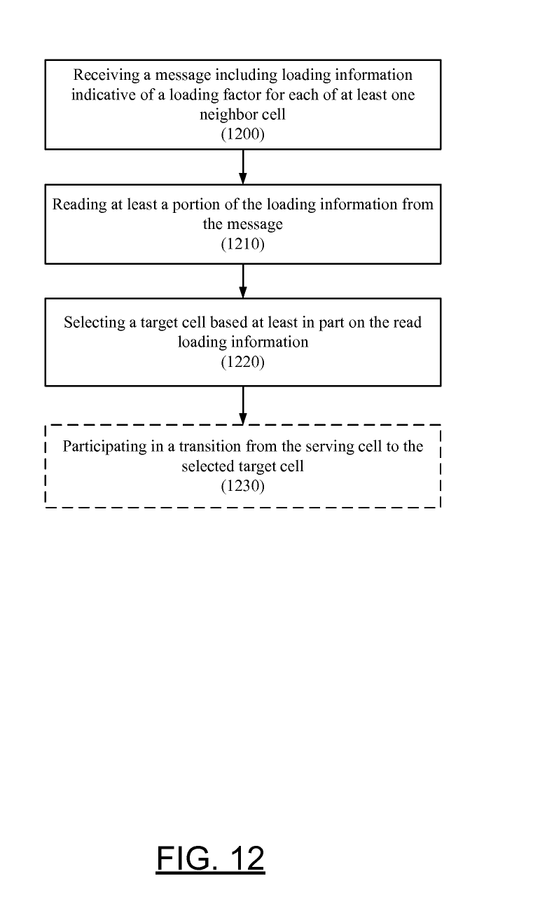

FIG. 12 illustrates a flowchart according to an example method for making a cell transition decision based on cell loading in accordance with some example embodiments. In this regard, FIG. 12 illustrates a method that can be performed by a wireless communication device 102 in accordance with some example embodiments. One or more of processing circuitry 610, processor 612, memory 614, transceiver(s) 616, or selection control module 618 can, for example, provide means for performing one or more of the operations illustrated in and described with respect to FIG. 12.

Operation 1200 can include the wireless communication device 102 receiving a message including loading information indicative of a loading factor for each of at least one neighbor cell. The message can be a message sent by a serving base station, such as serving base station 104, serving eNB 204, serving eNB 404, serving eNB 505, or the like. Operation 1210 can include the wireless communication device 102 reading at least a portion of the loading information from the message. In some example embodiments, the message can be a message sent to (e.g., addressed to) the wireless communication device 102. Alternatively, in some example embodiments, the message can be a broadcast message, such as a system information message, that can be broadcast within the serving cell by the serving base station. In this regard, the message that can be received in operation 1200 can be a message that can be sent by a serving base station attendant to performance of operation 1030 or operation 1130.

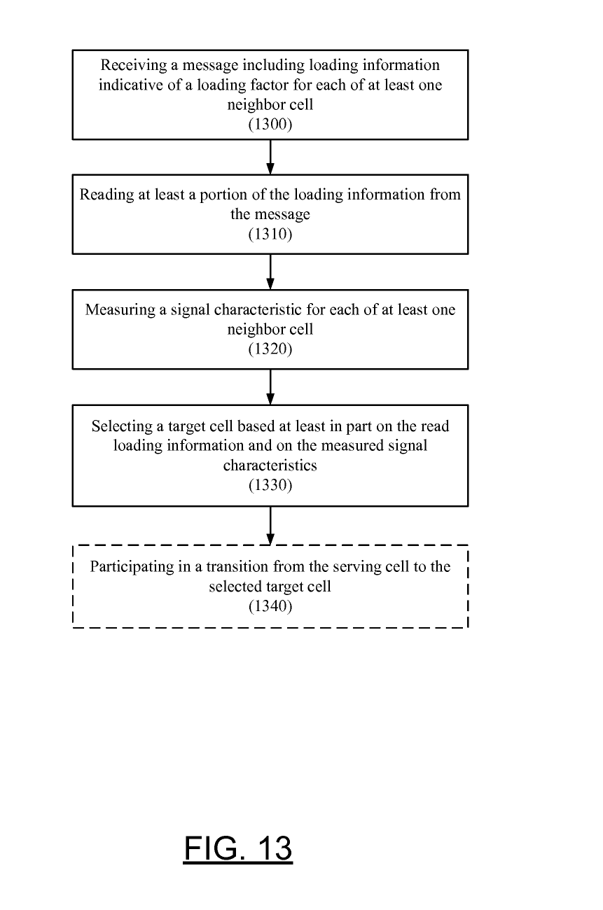

Operation 1220 can include the wireless communication device 102 selecting a target cell for transition based at least in part on the read loading information. In this regard, the wireless communication device 102 can evaluate candidate neighbor cells based on their respective loading factors and can select a candidate neighbor cell as a target cell for transition based at least in part on the evaluation. In some example embodiments, such as that illustrated in and described below with respect to FIG. 13, operation 1220 can include the wireless communication device 102 considering one or more further factors, such as one or more measured signal characteristics of candidate neighbor cells, in addition to the loading information in selecting the target cell.

The method can optionally further include operation 1230, which can include the wireless communication device 102 participating in a transition from the serving cell to the selected target cell. In some instances, operation 1230 can include the wireless communication device 102 autonomously reselecting to the selected target cell. Alternatively, in some instances, operation 1230 can include the wireless communication device 102 transitioning to the selected target cell under network direction and/or with network assistance, such as through redirection or handover. For example, in some example embodiments, the wireless communication device 102 can send a measurement report and/or other message to trigger the network to initiate a transition to the selected target cell.

In some example embodiments, the selection control module 618 can be configured to select a target cell based on measured signal characteristics of candidate neighbor cells in addition to received loading information. For example, the wireless communication device 102 can be configured to measure one or more signal characteristics of a candidate neighbor cell, such as a pilot strength measurement, signal to noise ratio (SNR), signal to noise plus interference ratio (SINR), reference signal received power (RSRP), reference signal received quality (RSRQ), received signal strength indicator (RSSI), received signal code power (RSCP), and/or other signal characteristic that can be measured or otherwise observed for a neighbor cell. The selection control module 618 of some example embodiments can accordingly be configured to factor both signal quality measurements and loading factors of neighboring cells when selecting a target cell. Thus, for example, while an example neighbor cell can have the best signal strength of neighboring cells based on measurements, if the neighbor cell is heavily loaded relative to one or more further neighbor cells offering a good signal quality, it can be eliminated from consideration.

In some embodiments, the selection control module 618 can be configured to determine a selection favorability metric for a neighbor cell based on a combination of a measured signal quality and a loading factor for the neighbor cell. For example, the selection control module 618 can be configured to assign a first weight (e.g., a weight between 0 and 1) to a loading factor for a cell and a second weight (e.g., a weight equal to 1—the first weight) to a measured signal quality of the cell. The selection favorability metric can accordingly be derived from the weighted combination of the loading factor and measured signal quality. The selection control module 618 can then compare the derived selection favorability metrics for candidate neighbor cells and select the candidate neighbor cell having the best selection favorability metric as the target cell for transition.

FIG. 13 illustrates a flowchart according to another example method for making a cell transition decision based on cell loading in accordance with some example embodiments. More particularly, FIG. 13 illustrates a method that can be performed by a wireless communication device 102 in accordance with some example embodiments of the method of FIG. 12 in which measured signal quality of one or more neighbor cells can be considered in addition to loading information for the neighbor cells. One or more of processing circuitry 610, processor 612, memory 614, transceiver(s) 616, or selection control module 618 can, for example, provide means for performing one or more of the operations illustrated in and described with respect to FIG. 13.

Operation 1300 can include the wireless communication device 102 receiving a message including loading information indicative of a loading factor for each of at least one neighbor cell. In this regard, operation 1300 can correspond to an embodiment of operation 1200. Operation 1310 can include the wireless communication device 102 reading at least a portion of the loading information from the message. Operation 1310 can accordingly correspond to an embodiment of operation 1210.

Operation 1320 can include the wireless communication device 102 measuring a signal characteristic for each of at least one neighbor cell. The measured signal characteristic can be a measurement of signal strength, signal quality, and/or other characteristic that can be measured or otherwise observed for a given cell signal. By way of non-limiting example, operation 1320 can include measuring one or more of a pilot strength measurement, SNR, SINR, RSRP, RSRQ, RSSI, RSCP, and/or the like for a respective neighbor cell.

It will be appreciated that the method of FIG. 13 is not limited to any relative ordering of operation 1320. In this regard, operation 1320 can be performed in any ordering relative to operations 1300 and 1310, including, for example, prior to performance of one or both of operations 1300 and 1310, concurrent with performance of one or both of operations 1300 and 1310, or after performance of both operations 1300 and 1310.

Operation 1330 can include the wireless communication device 102 selecting a target cell based at least in part on the read loading information and on the measured signal characteristics. For example, in some embodiments, operation 1330 can include the wireless communication device 102 deriving selection favorability metrics for one or more neighbor cells based on a combination of their respective loading factors and measured signal qualities, as described above, and evaluating the neighbor cells based on their selection favorability metrics.

In some example embodiments, the method of FIG. 13 can further include operation 1340, which can include the wireless communication device 102 participating in a transition from the serving cell to the selected target cell. In this regard, operation 1340 can correspond to an embodiment of operation 1230.

In some embodiments and/or instances in which the wireless communication device 102 can transition to a selected target cell under network direction and/or with network assistance, such as through redirection or handover, the wireless communication device 102 can be configured to influence the network to transition the wireless communication device 102 to the selected target cell through measurement reports that can be sent by the wireless communication device 102.

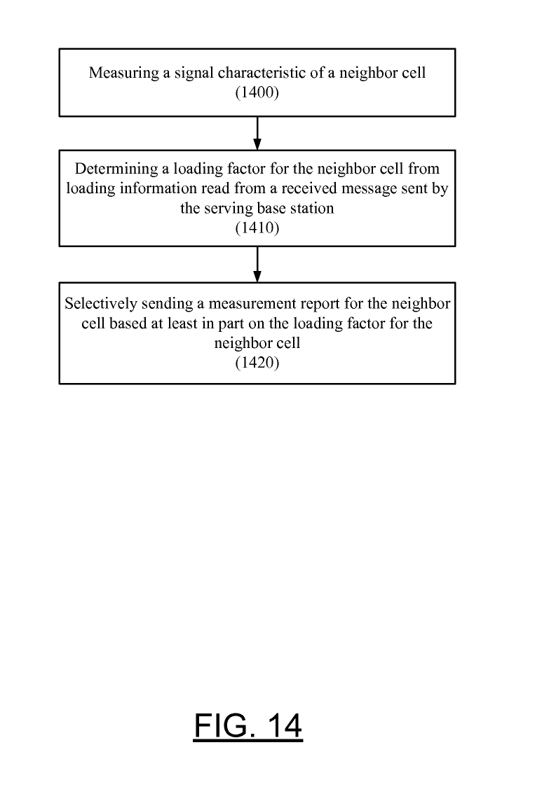

FIG. 14 illustrates a flowchart according to an example method for influencing transition to a neighbor cell based on cell loading in accordance with some example embodiments. More particularly, FIG. 14 illustrates an example method in which a wireless communication device 102 can selectively send or not send a measurement report for a respective neighbor cell based on the loading factor of the neighbor cell. One or more of processing circuitry 610, processor 612, memory 614, transceiver(s) 616, or selection control module 618 can, for example, provide means for performing one or more of the operations illustrated in and described with respect to FIG. 14.

Operation 1400 can include the wireless communication device 102 measuring a signal characteristic of a neighbor cell. Operation 1410 can include the wireless communication device 102 determining a loading factor for the neighbor cell from loading information read from a received message sent by the serving base station. For example, operation 1410 can be performed based on loading information that can be read by the wireless communication device 102 attendant to performance of operation 1210 or operation 1310.

It will be appreciated that embodiments are not limited to any particular ordering of operations 1400 and 1410. In this regard, while illustrated as following operation 1400, in some example embodiments, operation 1410 can be performed prior to operation 1400. Alternatively, in some example embodiments, operations 1400 and 1410 can be performed concurrently.

Operation 1420 can include the wireless communication device 102 selectively sending a measurement report for the neighbor cell based at least in part on the loading factor for the neighbor cell. For example, in some instances in which the measured signal characteristic of the neighbor cell determined in operation 1400 satisfies a threshold for sending a measurement report, but the loading factor for the neighbor cell exceeds a threshold and/or is greater than a loading factor for another candidate neighbor cell having a suitable signal quality, operation 1420 can include the wireless communication device 102 determining to not send a measurement report for the neighbor cell to avoid triggering a transition to the neighbor cell. As another example, in an instance in which a measured signal characteristic for the neighbor cell is not better than a second neighbor cell, but the loading on the neighbor cell is less than the second neighbor cell, operation 1420 can include the wireless communication device 102 sending a measurement report for the neighbor cell instead of for the second neighbor cell so as to trigger a transition to the neighbor cell rather than the second neighbor cell.

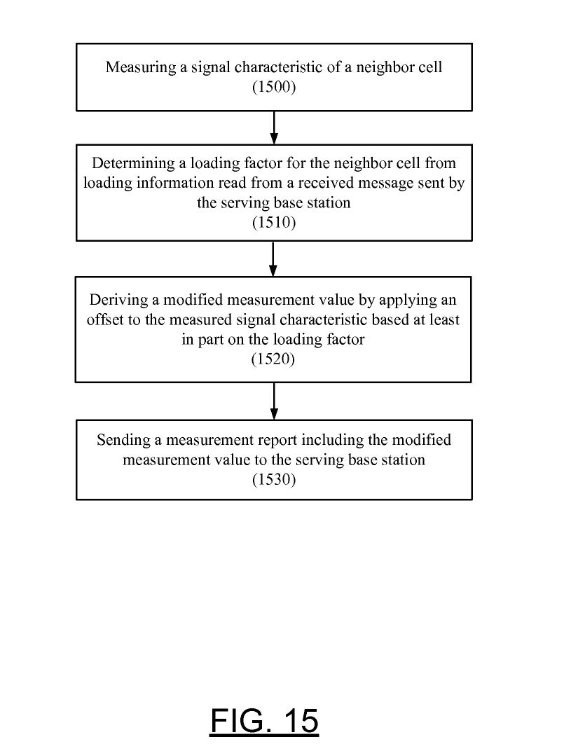

In some example embodiments, the wireless communication device 102 can be configured to influence transition to a selected target cell by sending a measurement report for a neighbor cell that includes a measurement value modified from an actual measured signal characteristic based on the loading factor for the neighbor cell. FIG. 15 illustrates a flowchart according to an example method for influencing transition to a neighbor cell based on cell loading in accordance with some such example embodiments. One or more of processing circuitry 610, processor 612, memory 614, transceiver(s) 616, or selection control module 618 can, for example, provide means for performing one or more of the operations illustrated in and described with respect to FIG. 15.

Operation 1500 can include the wireless communication device 102 measuring a signal characteristic of a neighbor cell. Operation 5410 can include the wireless communication device 102 determining a loading factor for the neighbor cell from loading information read from a received message sent by the serving base station. For example, operation 1510 can be performed based on loading information that can be read by the wireless communication device 102 attendant to performance of operation 1210 or operation 1310.

It will be appreciated that embodiments are not limited to any particular ordering of operations 1500 and 1510. In this regard, while illustrated as following operation 1500, in some example embodiments, operation 1510 can be performed prior to operation 1500. Alternatively, in some example embodiments, operations 1500 and 1510 can be performed concurrently.

Operation 1520 can include the wireless communication device 102 deriving a modified measurement value by applying an offset to the measured signal characteristic based at least in part on the loading factor for the neighbor cell.

For example, if the loading factor indicates heavy loading, such as having a loading greater than a threshold, greater than another candidate neighbor cell, and/or the like, operation 1520 can include applying an offset selected to indicate a lower signal quality than that measured in operation 1500. In some such instances, the applied offset can be sufficient such that the modified measurement value satisfies a measurement threshold for triggering transition to the selected target cell.

As another example, if the loading factor indicates that the neighbor cell is lightly loaded such as having a loading that is less than a threshold, less than another candidate neighbor cell, and/or the like, operation 1520 can include applying an offset selected to indicate a higher signal quality than that measured in operation 1500.

Operation 1530 can include the wireless communication device 102 sending a measurement report including the modified measurement value to the serving base station. As such, through sending one or more modified measurement reports in accordance with such example embodiments, the wireless communication device 102 can influence transition to a selected target cell.

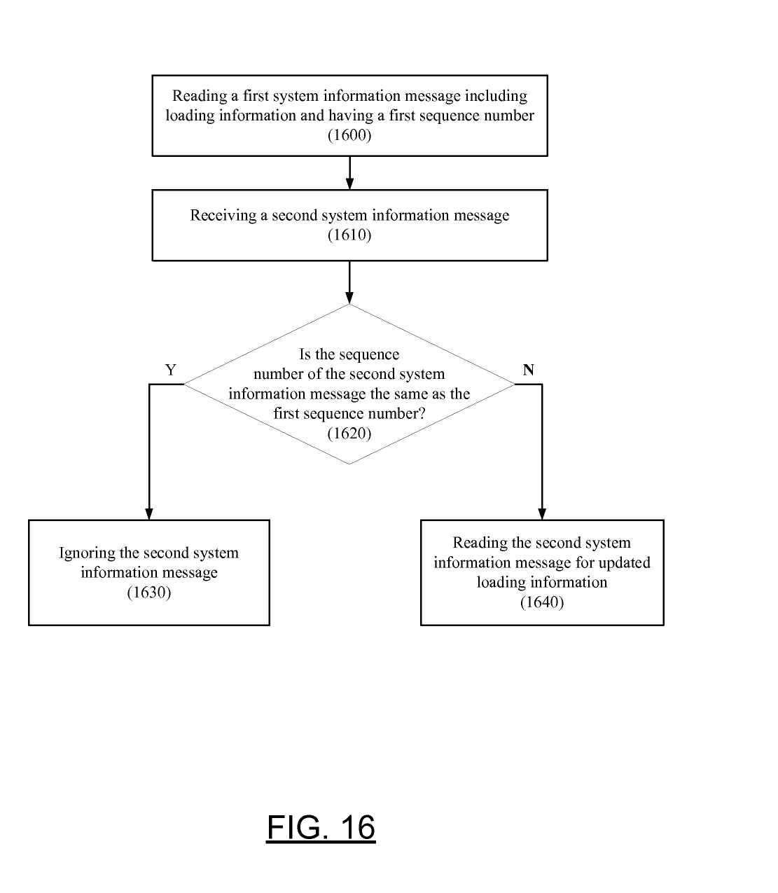

As discussed previously, in some embodiments, a base station can be configured to broadcast system information messages having a sequence number or other version indicator such that a wireless communication device 102 can selectively read a received system information message based on an observed sequence number. FIG. 16 illustrates a flowchart according to an example method that can be performed by wireless communication device 102 for selectively reading a system information message for updated loading information in accordance with some such example embodiments. One or more of processing circuitry 610, processor 612, memory 614, transceiver(s) 616, or selection control module 618 can, for example, provide means for performing one or more of the operations illustrated in and described with respect to FIG. 16.

Operation 1600 can include the wireless communication device 102 reading a first system information message including loading information. The first system information message can have an associated first sequence number. Operation 1610 can include the wireless communication device 102 receiving a second system information message.

Operation 1610 can include the wireless communication device 102 determining whether the sequence number of the second system information message is the same as the first sequence number. In this regard, the wireless communication device 102 can compare the sequence number of the second system information message to the first sequence number to determine if the sequence numbers are different (e.g., whether the sequence number of the second system information message is greater than the first sequence number).

In an instance in which it is determined that the sequence number of the second system information message is identical to the first sequence number, the method can proceed to operation 1630, which can include the wireless communication device 102 ignoring (e.g., not reading) the second system information message. If, however, it is determined that the sequence number of the second system information message differs from the first sequence number, the method can instead proceed to operation 1640, which can include the wireless communication device 102 can read the second system information message for updated loading information. For example, the wireless communication device 102 can listen to a control channel on which the second system information message can be broadcast in an instance in which it sees that a system information message with an updated sequence number is being broadcast. In this regard, the wireless communication device 102 of such example embodiments can rely on previously read loading information until there is an indication, such as through an updated sequence number, that a broadcast system information message includes updated loading information.

The various aspects, embodiments, implementations or features of the described embodiments can be used separately or in any combination. Various aspects of the described embodiments can be implemented by software, hardware or a combination of hardware and software. The described embodiments can also be embodied as a computer readable medium (or mediums) storing computer readable code including instructions that can be performed by one or more computing devices. The computer readable medium is any data storage device that can store data which can thereafter be read by a computer system. Examples of the computer readable medium include read-only memory, random-access memory, CD-ROMs, HDDs, DVDs, magnetic tape, and optical data storage devices. The computer readable medium can also be distributed over network-coupled computer systems so that the computer readable code is stored and executed in a distributed fashion.

In the foregoing detailed description, reference was made to the accompanying drawings, which form a part of the description and in which are shown, by way of illustration, specific embodiments in accordance with the described embodiments. Although these embodiments are described in sufficient detail to enable one skilled in the art to practice the described embodiments, it is understood that these examples are not limiting; such that other embodiments may be used, and changes may be made without departing from the spirit and scope of the described embodiments.

Further, the foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. The description of and examples disclosed with respect to the embodiments presented in the foregoing description are provided solely to add context and aid in the understanding of the described embodiments. The description is not intended to be exhaustive or to limit the described embodiments to the precise forms disclosed. It will be apparent to one of ordinary skill in the art that many modifications, alternative applications, and variations are possible in view of the above teachings. In this regard, one of ordinary skill in the art will readily appreciate that the described embodiments may be practiced without some or all of these specific details. Further, in some instances, well known process steps have not been described in detail in order to avoid unnecessarily obscuring the described embodiments.

What is claimed is:

1. A method for making a cell transition decision based at least in part on cell loading, the method comprising a wireless communication device:
receiving a message sent by an evolved Node B (eNB) associated with a serving cell for the wireless communication device, the message including loading information indicative of a loading factor for each of at least one neighbor cell, wherein the serving cell implements a Long Term Evolution (LTE) radio access technology (RAT);
reading at least a portion of the loading information from the message; and
selecting a target cell for transition from the at least one neighbor cell based at least in part on the read loading information.

2. The method of claim 1, further comprising the wireless communication device:
participating in a transition from the serving cell to the selected target cell.

3. The method of claim 1, wherein receiving the message comprises receiving at least one system information message broadcast by the eNB, the at least one system information message including loading information indicative of a loading factor for one or more neighbor cells.

4. The method of claim 3, wherein:
in an instance in which the at least one neighbor cell includes one or more intra-frequency neighbor cells, the received at least one system information message includes a system information block (SIB) 4 including loading information for the one or more intra-frequency neighbor cells;
in an instance in which the at least one neighbor cell includes one or more inter-frequency neighbor cells, the received at least one system information message includes a SIB 5 including loading information for the one or more inter-frequency neighbor cells;
in an instance in which the at least one neighbor cell includes one or more Universal Mobile Telecommunications System (UMTS) cells, the received at least one system information message includes a SIB 6 including loading information for the one or more UMTS cells;
in an instance in which the at least one neighbor cell includes one or more Global System for Mobile Communications (GSM) cells, the received at least one system information message includes a SIB 7 including loading information for the one or more GSM cells; and
in an instance which the at least one neighbor cell includes one or more Code Division Multiple Access 2000 (CDMA2000) cells, the received at least one system information message includes a SIB 8 including loading information for the one or more CDMA2000 cells.

5. The method of claim 3, wherein reading the at least a portion of the loading information comprises selectively reading a broadcast system information message for updated loading information based at least in part on a comparison between a sequence number associated with the broadcast system information message and a sequence number associated with a previously read system information message.

6. The method of claim 1, wherein selecting the target cell comprises selecting the target cell further based on a measured signal characteristic of the selected target cell.

7. The method of claim 6, further comprising the wireless communication device:
deriving a selection favorability metric for each of at least one neighbor cell, wherein each derived selection favorability metric is derived based at least in part on a weighted combination of the measured signal characteristic for a respective neighbor cell and the loading factor of the respective neighbor cell indicated by the read loading information; and
selecting the target cell based at least in part on the derived selection favorability metrics.

8. The method of claim 1, further comprising the wireless communication device:
measuring a signal characteristic of the selected target cell;
deriving a modified measurement value by applying an offset to the measured signal characteristic based at least in part on the loading factor of the selected target cell indicated by the read loading information; and
sending a measurement report including the modified measurement value to trigger transition to the selected target cell.

9. The method of claim 1, further comprising the wireless communication device:
selectively sending a measurement report for a neighbor cell based at least in part on the loading information.

10. The method of claim 1, wherein the at least one neighbor cell includes at least one neighbor cell implementing a legacy RAT having a circuit switched domain.

11. A wireless communication device comprising:
at least one transceiver, the at least one transceiver configured to send data to and receive data from one or more cellular networks;
and processing circuitry coupled with the at least one transceiver, the processing circuitry configured to control the wireless communication device to at least:
receive a message sent by a base station associated with a serving cell for the wireless communication device, the message including loading information indicative of a loading factor for each of at least one neighbor cell;
read at least a portion of the loading information from the message; and
select a target cell for transition from the at least one neighbor cell based at least in part on the read loading information.

12. The wireless communication device of claim 11, wherein the base station is an evolved Node B (eNB), and wherein the serving cell implements a Long Term Evolution (LTE) radio access technology (RAT).

13. The wireless communication device of claim 11, wherein the processing circuitry is configured to control the wireless communication device to receive the message at least in part by controlling the wireless communication device to receive at least one system information message broadcast by the base station, the at least one system information message including loading information indicative of a loading factor for one or more neighbor cells.

14. The wireless communication device of claim 11, wherein the processing circuitry is further configured to control the wireless communication device to select the target cell further based on a measured signal characteristic of the selected target cell.

15. A method for facilitating a cell transition decision by a wireless communication device based at least in part on cell loading, the method comprising a base station:
receiving loading factor data for one or more neighbor cells;
deriving loading information from the received loading factor data, the derived loading information being indicative of a loading factor for each of at least one neighbor cell of the one or more neighbor cells;
generating a message including at least a portion of the derived loading information; and
sending the message such that the message is receivable by at least one wireless communication device in a cell served by the base station.

16. The method of claim 15, wherein the base station is an evolved Node B (eNB), and wherein the cell served by the base station implements a Long Term Evolution (LTE) radio access technology (RAT).

17. The method of claim 15, wherein:
generating the message comprises generating a system information message; and
sending the message comprises broadcasting the system information message.

18. The method of claim 17, wherein:
in an instance in which the at least one neighbor cell includes one or more intra-frequency neighbor cells, the system information message includes a system information block (SIB) 4 including loading information for the one or more intra-frequency neighbor cells;
in an instance in which the at least one neighbor cell includes one or more inter-frequency neighbor cells, the system information message includes a SIB 5 including loading information for the one or more inter-frequency neighbor cells;
in an instance in which the at least one neighbor cell includes one or more Universal Mobile Telecommunications System (UMTS) cells, the system information message includes a SIB 6 including loading information for the one or more UMTS cells;
in an instance in which the at least one neighbor cell includes one or more Global System for Mobile Communications (GSM) cells, the system information message includes a SIB 7 including loading information for the one or more GSM cells; and
in an instance which the at least one neighbor cell includes one or more Code Division Multiple Access 2000 (CDMA2000) cells, the system information message includes a SIB 8 including loading information for the one or more CDMA2000 cells.

19. The method of claim 15, wherein receiving the loading factor data comprises receiving loading factor data via an interface configured to enable communication between the base station and a second base station, the second base station being associated with a neighbor cell.

20. The method of claim 15, wherein the cell implements a first radio access technology (RAT), and wherein receiving the loading factor data comprises receiving loading factor data provided by a control entity associated with one or more neighbor cells implementing a second RAT.
